(19) United States
(12) Patent Application Publication
(10) Pub. No.: US 2010/0190556 A1
(43) Pub. Date: Jul. 29, 2010

(54) INFORMATION STORAGE MEDIUM, GAME PROGRAM, AND GAME SYSTEM

(76) Inventor: Daniel Chan, San Francisco, CA (US)

Correspondence Address: GREENBERG TRAURIG (PHX), INTELLECTUAL PROPERTY DEPARTMENT, 2450 COLORADO AVENUE , SUITE 400E, SANTA MONICA, CA, 90404, US

(21) Appl. No.: 12/694,167

(22) Filed: Jan. 26, 2010

Related U.S. Application Data
(60) Provisional application No. 61/147,409, filed on Jan. 26, 2009.

(30) Foreign Application Priority Data
Jan. 26, 2009 (JP) 2009-14822
Jan. 26, 2009 (JP) 2009-14826
Jan. 26, 2009 (JP) 2009-14828

(51) Int. Cl. A63F 9/24; A63F 13/00

(52) U.S. Cl. 463/43; 463/42; 463/30

(57) ABSTRACT

Embodiments of the invention provide a computer-readable storage medium tangibly storing a game program for generating images in an object space viewed from a given viewpoint. The program causes a game system to function as an acceptance unit and a processing unit. The processing unit performs processing to create a severance plane, define a mesh structure for an object, determine whether the severance plane intersects the mesh structure, sever the object into multiple sub-objects, define mesh structures for the multiple sub-objects, and create and display caps for severed ends of the multiple sub-objects.

### RELATED APPLICATIONS

This application claims priority under 35 U.S.C. §119 to U.S. Provisional Patent Application No. 61/147,409 filed on Jan. 26, 2009, the entire contents of which is incorporated herein by reference. This application also claims priority under 35 U.S.C. §120 to Japanese Patent Application Nos. 2009-14822, 2009-14826, and 2009-14828, each filed on Jan. 26, 2009, the entire contents of which are incorporated herein by reference.

### BACKGROUND

Game systems, or image generation systems, can generate images such that they are viewed from a virtual camera (i.e., a given view point) in an object space. These game systems can include processing where a virtual player object can attack a virtual enemy object based on input information from a user (i.e., a player). For example, the player object can attack the enemy object with a weapon, such as a sword or gun. Conventional game systems, however, are unable to realistically represent the appearance of the enemy object during and after an attack that severs at least a portion of the enemy object into two or more pieces.

### SUMMARY

Some embodiments of the invention provide a computer-readable storage medium tangibly storing a program for generating images in a object space viewed from a given viewpoint. The program causes a game system used by a player to function as an acceptance unit which accepts player input information for a first object with a weapon in the object space, a display control unit which performs processing to display a severance line on a second object based on the player input information while in a specified mode, and a severance processing unit which performs processing to sever the second object along the severance line.

Some embodiments of the invention provide a computer-readable storage medium tangibly storing a game program for generating images in a object space viewed from a given viewpoint. The program causes a game system used by a player to function as an acceptance unit which accepts input information from the player, a representative point location information computation unit which defines representative points on an object and calculates location information for the representative points based on the input information, a splitting processing unit which performs splitting processing to determine whether the object should be split based on the input information and to split the object into multiple sub-objects if it has been determined that the object should be split, a splitting state determination unit which determines a splitting state of the object based on the location information of the representative points, and a processing unit which performs image generation processing and game parameter computation processing based on the splitting state of the object.

Some embodiments of the invention provide a computer-readable storage medium tangibly storing a game program for generating images in a object space viewed from a given viewpoint. The program causes a game system used by a player to function as an acceptance unit which accepts player input information from the player to destroy an object, a destruction processing unit which, upon acceptance of the input information, performs processing whereby the object is destroyed, and an effect control unit which controls the magnitude of effects representing the damage sustained by the object based on a size of a destruction surface of the object caused by the destruction processing unit.

Some embodiments of the invention provide a computer-readable storage medium tangibly storing a game program for generating images in a object space viewed from a given viewpoint. The program causes a game system used by a player to function as an acceptance unit which accepts player input information for a first object in the object space and a processing unit. The processing unit performs processing to create a severance plane based on the player input information, define a mesh structure for at least a second object, determine whether the severance plane intersects the mesh structure of the second object in the object space, if the severance plane and the second object intersect, sever the second object into multiple sub-objects with severed ends along the severance plane, define mesh structures for the multiple sub-objects, and create and display caps for the severed ends of the multiple sub-objects.

### DESCRIPTION OF THE DRAWINGS

FIG. 1 is a block diagram of a game system according to one embodiment of the invention.

FIGS. 2A and 2B are perspective views of a vertical attack produced in accordance with the game system of FIG. 1.

FIGS. 3A and 3B are perspective views of a horizontal attack produced in accordance with the game system of FIG. 1.

FIG. 4 is a perspective view of a vertical severance plane in accordance with the game system of FIG. 1.

FIG. 5 is a perspective view of a horizontal severance plane in accordance with the game system of FIG. 1.

FIG. 6 is a time-line of action modes in accordance with the game system f FIG. 1.

FIG. 7 is another perspective view of a vertical severance plane in accordance with the game system of FIG. 1.

FIGS. 8A-8D are perspective views of vertical severance planes and an enemy object in accordance with the game system of FIG. 1.

FIGS. 9A-9D are perspective views of horizontal severance planes and an enemy object in accordance with the game system of FIG. 1.

FIGS. 10A and 10B are perspective views of a player object and enemy object in accordance with the game system of FIG. 1.

FIG. 11 is a perspective view of a player object and multiple enemy objects in accordance with the game system of FIG. 1.

FIGS. 12A-12C are perspective views of enemy objects and severance planes in accordance with the game system of FIG. 1.

FIG. 13 is a flowchart illustrating action mode processing in accordance with the game system of FIG. 1.

FIG. 14 is a flowchart illustrating attack processing in accordance with the game system of FIG. 1.

FIG. 15 is a flowchart illustrating severance processing in accordance with the game system of FIG. 1.

FIG. 16 is a block diagram of a game system according to another embodiment of the invention.

FIG. 17 is a perspective screen view of a player object and enemy objects in accordance with the game system of FIG. 16.

FIGS. 18A and 18B are front views of a complete enemy object and a vertically split enemy object, respectively, in accordance with the game system of FIG. 16.

FIGS. 19A and 19B are front views of a complete enemy object and a horizontally split enemy object, respectively, in accordance with the game system of FIG. 16.

FIGS. 20A and 20B are top views of a player object, an enemy object, and a vertical virtual plane in accordance with the game system of FIG. 16.

FIGS. 21A and 21B are side views of a player object, an enemy object, and a horizontal virtual plane in accordance with the game system of FIG. 16.

FIG. 22 is a front view of a model object subject to splitting in accordance with the game system of FIG. 16.

FIG. 23 is another front view of a model object subject to splitting in accordance with the game system of FIG. 16.

FIG. 24 is a table storing object information in accordance with the game system of FIG. 16.

FIG. 25 is a front view of a split object in accordance with the game system of FIG. 16.

FIG. 26 is a partial front view of an object in accordance with the game system of FIG. 16.

FIG. 27 is a front view of a model object subject to splitting in accordance with the game system of FIG. 16.

FIGS. 28A and 28B are tables storing object identification in accordance with the game system of FIG. 16.

FIGS. 29A and 29B are front views of a split object in accordance with the game system of FIG. 16.

FIGS. 30A and 30B are front views of a split object and effect display patterns in accordance with the game system of FIG. 16.

FIG. 31 is a flowchart illustrating splitting state processing based on representative point information in accordance with the game system of FIG. 16.

FIG. 32 is a flowchart illustrating splitting state processing based on split line information in accordance with the game system of FIG. 16.

FIG. 33 is a block diagram of a game system according to yet another embodiment of the invention.

FIGS. 34A and 34B are perspective views of severed enemy objects and effect displays in accordance with the game system of FIG. 33.

FIGS. 35A, 35B, and 35C are perspective views of an enemy object and severance planes in accordance with the game system of FIG. 33.

FIGS. 36A and 36B are perspective views of severed enemy objects and effect displays in accordance with the game system of FIG. 33.

FIG. 37 is a table storing virtual plane information in accordance with the game system of FIG. 33.

FIG. 38 is a flowchart illustrating effect display processing in accordance with the game system of FIG. 33.

FIGS. 39A and 39B are front views of a complete enemy object and a severed enemy object, respectively, in accordance with the game system of FIG. 33.

FIG. 40 is a block diagram of a game system according to yet another embodiment of the invention.

FIG. 41 is a flowchart illustrating severance and capping processing in accordance with the game system of FIG. 40.

FIG. 42 is a perspective view of an object collision sphere subject to severing in accordance with the game system of FIG. 40.

FIG. 43 is a front view of model objects subject to severing in accordance with the game system of FIG. 40.

FIG. 44 is a front view of a triangle defining an object mesh in accordance with the game system of FIG. 40.

FIG. 45 is a front view of a plurality of mesh triangles along a severance line in accordance with the game system of FIG. 40.

FIG. 46 is a front view mesh triangle split along a severance line in accordance with the game system of FIG. 40.

FIG. 47 is a front view of polygons created by edge loops in accordance with the game system of FIG. 40.

FIG. 48 is a front view of a reference triangle in accordance with the game system of FIG. 40.

FIG. 49 is a front view of reference triangles grouped in accordance with the game system of FIG. 40.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Some embodiments of the invention include a game system 10 or image generation system. The game system 10 can execute a game program (e.g., a videogame) based on a input information from a player (i.e., a user). The game system 10 and the game program can include a player object controlled by the player and various other objects, such as enemy objects, in an object space. The game program can be a role playing game (RPG), action game, or simulation game or other game that includes real-time game play in some embodiments. The game system 10 can involve processing whereby the player object can attack the enemy object. More specifically, upon accepting attack input information from the player, the game system 10 can provide processing which causes the player object to perform an attacking motion of cutting, and possibly severing, at least a portion of the enemy object with a weapon.

The following paragraphs describe physical components of the game system 10 according to one embodiment of the invention.

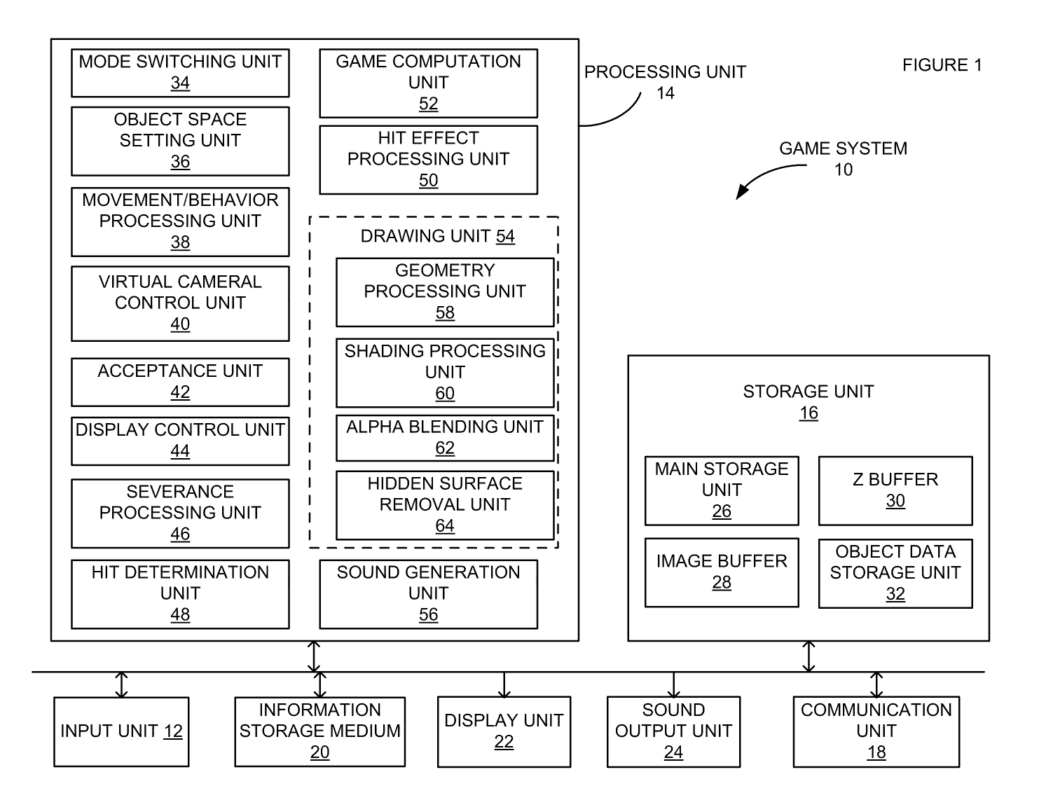

As shown in FIG. 1, the game system 10 can include an input unit 12, a processing unit 14, a storage unit 16, a communication unit 18, an information storage medium 20, a display unit 22, a sound output unit 24. In some embodiments, the game system can include different configurations of fewer or additional components.

The input unit 12 can be a device used by the player to input information. Examples of the input unit 12 can be, but are not limited to, game controllers, levers, buttons, steering wheels, microphones, and touch panel displays. In some embodiments, the input unit 12 can detect player input information through key inputs from directional keys or buttons (e.g., “RB” button, “LB” button, “X” button, “Y” button, etc.). The input unit 12 can transmit the input information from the player to the processing unit 14.

In some embodiments, the input unit 12 can include an acceleration sensor which detects acceleration along three axes, a gyro sensor which detects angular acceleration, and/or an image pickup unit. The input device 12 can, for instance, be gripped and moved by the player, or worn and moved by the player. Also, in some embodiments, the input device 12 can be a controller modeled upon an actual tool, such as a sword-type controller gripped by the player, or a glove-type controller worn by the player. In other embodiments, the input device 12 can be integral with the game system 10, such as keypads or touch panel displays on portable game devices, portable phones, etc. Further, the input device 12 of some embodiments can include a device integrating one or more of the above examples (e.g., a sword-type controller including buttons).

The storage unit 16 can serve as a work area for the processing unit 14, communication unit 18, etc. The function of the storage unit 16 can be implemented by memory such as Random Access Memory (RAM), Video Random Access Memory (VRAM), etc. The storage unit 16 can include a main storage unit 26, an image buffer 28, a Z buffer 30, and an object data storage unit 32.

The object data storage unit 32 can store object data. For example, the object data storage unit 32 can store identifying points of parts making up an object (i.e., a player object or an enemy object), such as points of a head part, a neck part, an arm part, etc., or other representative points at an object level, as described below.

The communication unit 18 can perform various types of control for conducting communication with, for example, host devices or other game systems. Functions of the communication unit 18 can be implemented via a program or hardware such as processors, communication application-specific integrated circuits (ASICs), etc.

The information storage medium 20 can be a computer-readable medium and can store the game program, other programs, and/or other data. The function of the information storage medium 20 can be implemented by an optical compact or digital video disc (CD or DVD), a magneto-optical disc (MO), a magnetic disc, a hard disc, a magnetic tape, memory such as Read-Only Memory (ROM), a memory card, etc. In addition, personal data of players and/or saved game data can also be stored on the information storage medium 20. In some embodiments, object data stored on the information storage medium 20 can be loaded into the object data storage unit 32 through the execution of the game program.

In some embodiments, the game program can be downloaded from a server via a network and stored in the storage unit 16 or on the information storage medium 20. Also, the game program can be stored in a storage unit of the server.

The processing unit 14 can perform data processing in the game system 10 based on the game program and/or other programs and data loaded or inputted by the information storage medium 20. The display unit 22 can output images generated by the processing unit 14. The function of the display unit 22 can be implemented via a cathode ray tube (CRT), liquid crystal display (LCD), touch panel display, head-mounted display (HMD), etc. The sound output unit 24 can output sound generated by the processing unit 14, and its function can be implemented via speakers or headphones.

The processing unit 14 can perform various types of processing using the main storage unit 171 within the storage unit 170 as a work area. The functions of the processing unit 100 can be implemented via hardware such as a processor (e.g., a CPU, DSP, etc.), ASICs (e.g., a gate array, etc.), or a program.

In some embodiments, the processing unit 14 can include a mode switching unit 34, an object space setting unit 36, a movement and behavior processing unit 38, a virtual camera control unit 40, an acceptance unit 42, a display control unit 44, a severance processing unit 46, a hit determination unit 48, a hit effect processing unit 50, a game computation unit 52, a drawing unit 54, and a sound generation unit 56. In some embodiments, the game system can include different configurations of fewer or additional components.

The mode switching unit 34 can perform processing to switch from a normal mode to a specified mode and, conversely, switch from a specified mode to a normal mode. For example, the mode switching unit 32 can perform processing to switch from the normal mode to the specified mode when specified mode switch input information has been accepted from the player.

The object space setting unit 36 can perform processing to arrange and set up various types of objects (i.e., objects consisting of primitives such as polygons, free curvatures, and subdivision surfaces), such as player objects, enemy objects, buildings, ballparks, vehicles, trees, columns, walls, maps (topography), etc. in the object space. More specifically, the object space setting unit 36 can determine the location and angle of rotation, or similarly, the orientation and direction, of the objects in a world coordinate system, and arrange the objects at those locations (e.g., X, Y, Z) and angles of rotation (e.g., about the X, Y, and Z axes).

The movement and behavior processing unit 38 can perform movement and behavior computations, and/or movement and behavior simulations, of player objects, enemy objects, and other objects, such as vehicles, airplanes, etc. More specifically, the movement and behavior processing unit 38 can perform processing to move (i.e., animate) objects in the object space and cause the objects to behave based on control data inputted by the player, programs (e.g., movement and behavior algorithms), or various types of data (e.g., motion data). The movement and behavior processing unit 38 can perform simulation processing which successively determines an object's movement information (e.g., location, angle of rotation, speed, and/or acceleration) and behavior information (e.g., location or angle of rotation of part objects) for each frame. A frame is a unit of time, for example, 1/60 of a second, in which object movement and behavior processing, or simulation processing, and image generation processing can be carried out.

The movement and behavior processing unit 38 can also perform processing which causes the player object to move based on directional instruction input information (e.g., left directional key input information, right directional key input information, down directional key input information, up directional key input information) if the input information is accepted while in the normal mode. For example, the movement and behavior processing unit 38 can perform behavior computations which cause the player object to attack other objects based on input information the player. In addition, the movement and behavior processing unit 38 can provide control such that the player object is not moved when directional instruction input information is accepted while in the specified mode.

The virtual camera control unit 40 can perform virtual camera, or view point, control processing to generate images which can be seen from a given (arbitrary) view point in the object space. More specifically, the virtual camera control unit 40 can perform processing to control the location or angle of rotation of a virtual camera or processing to control the view point location and line of sight direction.

For example, when the player object is filmed by the virtual camera from behind, the virtual camera location or angle of rotation (i.e., the orientation of the virtual camera) can be controlled so that the virtual camera tracks the change in location or rotation of the player object. In this case, the virtual camera can be controlled based on information such as the player object's location, angle of rotation, speed, etc., as obtained by the movement and behavior processing unit 38.

In some embodiments, control processing can be performed whereby the virtual camera is rotated by a predetermined angle of rotation or moved along a predetermined movement route. In this case, the virtual camera can be controlled based on virtual camera data for specifying the location, movement route, and/or angle of rotation. If multiple virtual cameras (view points) are present, the control described above can be performed for each virtual camera.

The acceptance unit 42 can accept player input information. For example, the acceptance unit 42 can accept player attack input information, specified mode switch input information, directional instruction input information, etc. In some embodiments, the acceptance unit 42 can accept specified mode switch input information from the player only when a given game value is at or above a predetermined value.

The display control unit 44 can perform processing to display severance lines on enemy object or other object displayed by the display unit 22 based on player attack input information under specified conditions. For example, the display control unit 44 can display severance lines when attack input information has been accepted while in the specified mode. As further described below, severance lines can be virtual lines illustrating where an object is to be severed.

In addition, the display control unit 44 can perform processing to move severance lines based on accepted directional instruction input information from the player. The display control unit 44 can display severance lines based on the attack direction derived from attack input information, the type of weapon the player object is equipped with, the type of the other object being attacked, and/or the movement and behavior of the other object. The display control unit 44 also can display the severance lines while avoiding non-severable regions if non-severable regions have been defined for the other object.

The severance processing unit 46 can define a severance plane of the other object based on the attack direction from which the player object attacks the other object, can determine if the other object is to be severed, and can perform the processing to sever the other object along a severance line if the other object is to be severed. The processing of severing the other object along a severance line can result in the other object being separated into multiple objects along the boundary of the defined severance plane. The severance processing unit 46 can perform processing whereby, upon determining that the other object is to be severed, the vertices of the split multiple objects are determined in real-time based on the severance plane and the multiple objects are generated and displayed based on the determined vertices.

The hit determination unit 48 can perform hit determination between the player object and an enemy object (or other object). The player object and the enemy object can each have weapons (e.g., virtual swords, boomerangs, axes, etc.). The hit determination unit 48 can perform processing to determine if a player object or an enemy object has been hit based on, for example, the hit region of the player object and the hit region of the enemy object.

The game computation unit 52 can perform game processing based on the game program or input data from the input unit 12. Game processing can include starting the game if game start conditions have been satisfied, processing to advance the game (e.g., to a subsequent stage or level), processing to arrange objects such as player objects, enemy objects, and maps, processing to display objects, processing to compute game results, processing to terminate the game if game termination conditions have been satisfied, etc. The game computation unit 52 can also compute game parameters, such as results, points, strength, life, etc.

The game computation unit 52 can provide the game with multiple stages or levels. At each stage, processing can be performed to determine if the player object has defeated a predetermined number of enemy objects present in that stage. In addition, processing can be performed to modify the strength level of the player object and the strength level of enemy objects based on hit determination results. For example, when player attack input information is inputted and accepted, processing can be performed to cause the player object to move and behave (i.e., execute an attacking motion) based on the player attack input information, and if it is determined that the enemy object has been hit, a predetermined value (e.g., a damage value corresponding to the attack) can be subtracted from the strength level of the enemy object. When the strength level of an enemy object reaches zero, the enemy object is considered to have been defeated. In some embodiments, the game computation unit 52 can perform processing to modify the strength level of an enemy object to zero when it is determined that the enemy object has been severed.

Furthermore, when the player object sustains an attack from an enemy object, processing can be performed to subtract a predetermined value from the strength level of the player object. If the strength level of the player object reaches zero, the game can be terminated.

The hit effect processing unit 54 can perform hit effect processing when it has been determined that the player object has hit an enemy object. For example, the hit effect processing unit 54 can perform image generation processing whereby liquid or light is emitted from a severance plane of the enemy object when the enemy object is determined to have been severed. In addition, the hit effect processing unit 54 can perform effect processing with different patterns in association with different severance states. For example, a pixel shader can be used to draw an effect discharge with different drawing patterns when an enemy object has been severed.

The drawing unit 56 can perform drawing processing based on processing performed by the processing unit 12 to generate and output images to the display unit 22. In some embodiments of the invention, the drawing unit 56 can include a geometry processing unit 58, a shading processing unit 60, an α blending unit 62, and a hidden surface removal unit 64.

If “three-dimensional” game images are to be generated, coordinate conversion (such as world coordinate conversion or camera coordinate conversion), clipping processing, transparency conversion, or other geometry processing can be carried out, and drawing data (i.e., object data such as location coordinates of primitive vertices, texture coordinates, color data, normal vector or α value, etc.) can be generated based on the results of this processing. Then, based on the drawing data, the object (e.g., one or multiple primitives) which has been subjected to transparency conversion, or geometry processing, can be drawn in the image buffer 28. Images which can be seen from a virtual camera in the object space are generated as a result. If multiple virtual cameras are present, drawing processing can be performed to allow images seen from each of the virtual cameras to be displayed as segmented images on a single screen. The image buffer 28 can be a buffer capable of storing image information in pixel units, such as a frame buffer or intermediate buffer (e.g., a work buffer). In some embodiments, the image buffer 28 can be video random access memory (VRAM). In one embodiment, vertex generation processing (tessellation, curved surface segmentation, polygon segmentation) can be performed as necessary.

The geometry processing unit 58 can perform geometry processing on objects. More specifically, the geometry processing unit 58 can perform geometry processing such as coordinate conversion, clipping processing, transparency conversion, light source calculations, etc. After geometry processing, object data (e.g., object vertex location coordinates, texture coordinates, color or brightness data, normal vector, a level, etc.) can be saved in the object data storage unit 32.

The shading processing unit 60 can perform shading processing to shade objects. More specifically, the shading processing unit 60 can adjust the brightness of drawing pixels of objects based on the results of light source computation (e.g., shade information computation) performed by the geometry processing unit 58. In some embodiments, light source computation can be conducted by the shading processing unit 60 instead of, or in addition to, the geometry processing unit 58. Shading processing carried out on objects can include, for example, flat shading, Gourand shading, Phong shading or other smooth shading.

The α blending unit 62 can perform translucency compositing processing (normal a blending, additive α blending, subtractive a blending, etc.) based on α values. For example, in the case of normal α blending, processing of the following formulas (1), (2), and (3) can be performed.

RQ=(1−α)×R1+α×R2 (1)

GQ=(1−α)×G1+α×G2 (2)

BQ=(1−α)×B1+α×B2 (3)

Furthermore, in the case of additive a blending, processing of the following formulas (4), (5), and (6) can be performed.

RQ=R1+α×R2 (4)

GQ=G1+α×G2 (5)

BQ=B1+α×B2 (6)

Additionally, in the case of subtractive a blending, processing of the following formulas (7), (8), and (9) can be performed.

RQ=R1−α×R2 (7)

GQ−=G1−α×G2 (8)

BQ=B1−α×B−2 (9)

In the above equations, R1, G1, and B1 can be RGB components of the image (original image) which has already been drawn by the image buffer 28, and R2, G2, and B2 can be RGB components which are to be drawn by image buffer 28. Also, RQ, GQ, and BQ can be RGB components of the image obtained through α blending. An α value is information which can be stored in association with each pixel, texel, or dot, for example, plus alpha information other than color information. α values can be used as mask information, translucency, opacity, bump information, etc.

The hidden surface removal unit 64 can use the Z buffer 30 (e.g., a depth buffer), which stores the Z values (i.e., depth information) of drawing pixels to perform hidden surface removal processing via a Z buffer technique (i.e., a depth comparison technique). More specifically, when the drawing pixels corresponding to an object's primitives are to be drawn, the Z values stored in the Z buffer 30 can be referenced. The referenced Z value from Z buffer 30 and the Z value at the drawing pixel of the primitive are compared, and if the Z value at the drawing pixel is a Z value which would be in front when viewed from the virtual camera (e.g., a smaller Z value), drawing processing for that drawing pixel can be performed and the Z value in the Z buffer 30 can be updated to a new Z value.

The sound generation unit 56 can perform sound processing based on processing performed by processing unit 14, generate game sounds such as background music, effect sounds, voices, etc., and output them to the sound output unit 24.

The game system 10 can have a single player mode or can also support a multiplayer mode. In the case of multiplayer modes, the game images and game sounds provided to the multiple players can be generated using a single terminal. In addition, the communication unit 18 of the game system 10 can transmit and receive data (e.g., input information) to and from one or multiple other game systems connected via a network through a transmission line, communication circuit, etc. to implement on-line gaming.

The following paragraphs describe execution of the game system 10 according to one embodiment of the invention.

To enable the player to recognize a severance plane of the enemy object, the game system 10 can enter a specified mode in which relative time is slowed down (e.g., enemy movement is slowed) and a severance line can be displayed before the player object attacking motion is executed. As a result, the enemy object can be severed by a straight cut along the severance line, thus making it possible to realistically represent the appearance of an enemy object being attacked.

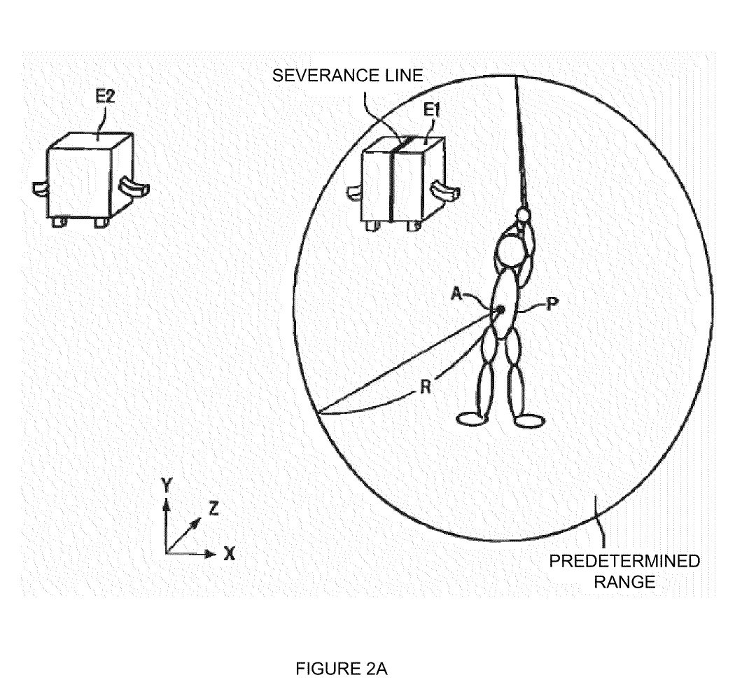

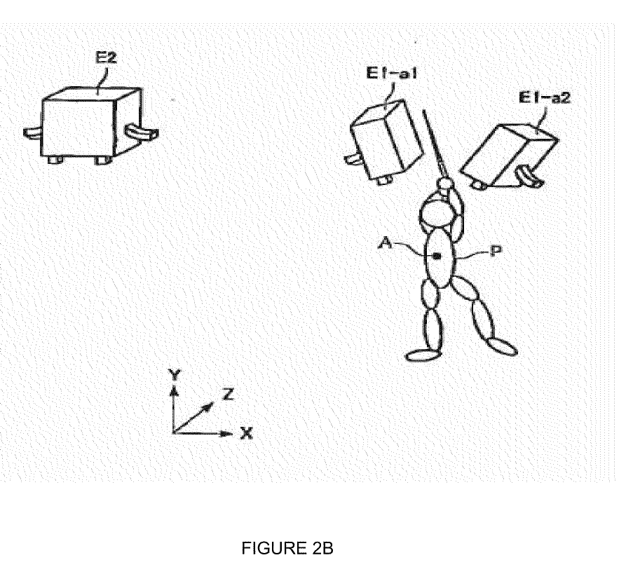

For example, as shown in FIG. 2A, upon accepting “vertical cut attack input information” inputted by the player, a vertical severance line is displayed for an enemy object E1 located within a specified range.

The severance line is displayed so long as “vertical cut attack input information” is continuously being accepted from the player. Once “vertical cut attack input information” is no longer continuously being accepted from the player (e.g., it is no longer detected), an attack motion is initiated whereby the player object P delivers a vertical cut to the enemy object E1. As shown in FIG. 2, the vertical cut attacking motion is an action whereby the player object P swings its sword vertically along the severance line. If the player object P hits the enemy object E1, the processing of severing the enemy object E1 along the severance line is carried out. For instance, as shown in FIG. 2B, the processing of splitting enemy object E1 into objects E1-a1 and E1-a2 has been performed.

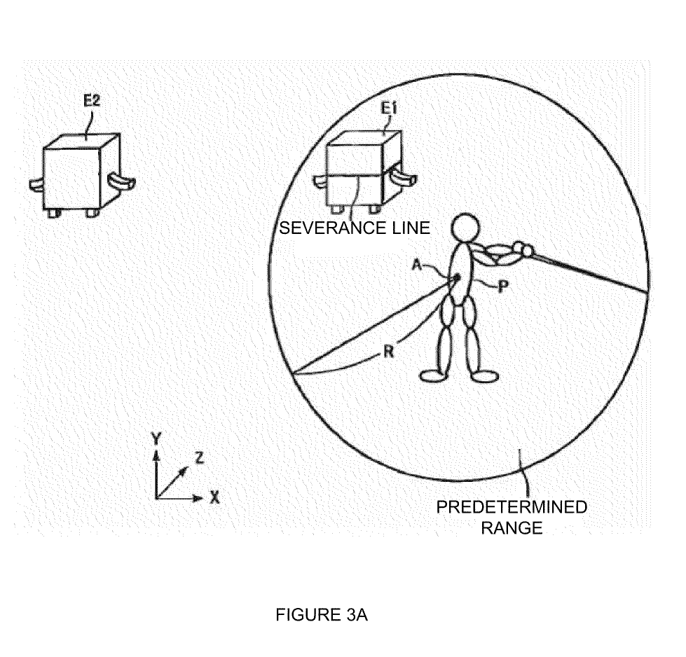

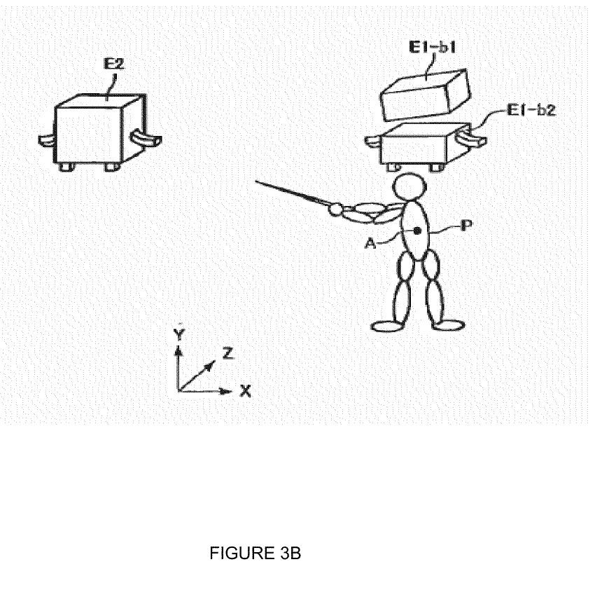

FIGS. 3A and 3B illustrate a horizontal cut attack. As shown in FIG. 3A, upon accepting “horizontal cut attack input information” from the player, a horizontal severance line is displayed for the enemy object E1 located within a specified range. The severance line is displayed so long as “horizontal cut attack input information” is continuously being accepted from the player, and once “horizontal cut attack input information” is no longer continuously being accepted from the player, the attack motion is initiated whereby the player object P delivers a horizontal cut to the enemy object E1. The horizontal cut attacking motion can be an action whereby the player object P swings its sword horizontally along the severance line, as shown in FIG. 3A. If the player object P hits the enemy object E1, the processing of severing the enemy object E1 along the severance line is carried out. As shown in FIG. 3B, the processing of splitting enemy object E1 into objects E1-b1 and E1-b2 has been performed.

In one embodiment, the game system 10 can switch between a normal mode and a specified mode. The processing to switch from the normal mode to the specified mode can be performed under specified conditions. The normal mode can be a mode in which the player object and enemy objects are made to move and behave at normal speed and the specified mode can be a mode in which enemy objects are made to move and behave slower than in normal mode.

In some embodiments, the processing of displaying a severance line for an enemy object is performed based on attack input information accepted only while in the specified mode. Also, while in the specified mode, control can be performed such that even if a player object sustains an attack from an enemy object, the strength level of the player object will not be reduced. Thus, a player can carefully observe the movement and behavior of the enemy object, identify a severance location, and perform a severing attack on the enemy object without worrying about attacks from the enemy object.

If “specified mode switch input information” inputted by a player has been accepted and a specified mode value (e.g., a given game value) is at or above a predetermined value, the processing of switching from normal mode to specified mode can be performed. In one example, the specified mode value can be the number of times the player object has attacked an enemy object or an elapsed time since the specified mode was last terminated.

Furthermore, after switching to the specified mode, the orientation of the player object and the orientation of the enemy object can be controlled so as to assume a predetermined directional relationship. For example, the orientation of the player object comes to be in the opposite direction to the orientation of the enemy object after switching to specified mode. In addition, the orientation of the virtual camera tracking the player object can similarly be controlled so that the orientation of the virtual camera comes to be in the opposite direction to the orientation of the enemy object.

When attack input information is accepted from the player in the specified mode, processing can be performed to display severance lines for enemy objects located within a specified range. If multiple enemy objects are located within the specified range, processing can performed to display severance lines for each of the multiple enemy objects present within the specified range. For example, as shown in FIGS. 2A and 3A, the specified range can be a sphere of radius R centered about representative point A of the player object P. The specified range can also be a cube, a cylinder of radius R, a prismatic column, etc., centered on representative point A of the player object P. The size of the specified range can be determined based on the length of the weapon with which the player object P is equipped. For example, if the weapon of player object P has a length of 100 units, a sphere of radius R=100 centered about representative point A of the player object P can be defined as the specified range.

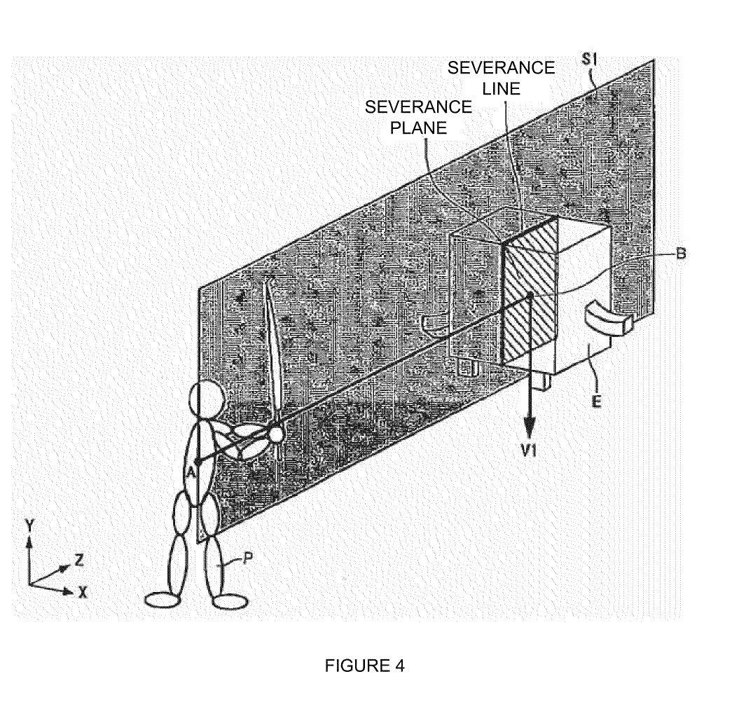

A severance plane can be defined in near real-time according to enemy object movement and behavior as well as player input, and severance lines can be displayed based on the defined severance plane. For example, FIG. 4 illustrates the player object P, the enemy object E, a severance line, and a severance plane during a vertical cut attack. Upon accepting vertical cut attack input information, a vertical attack direction V1 is defined, as shown in FIG. 4. A virtual plane S1 can then be determined based on a line connecting representative point A of player object P and representative point B of enemy object E and the vertical attack direction V1. The plane where virtual plane S1 and enemy object E intersect can then be defined as the severance plane. A set of points on the surface of the severance plane can then be displayed as a severance line.

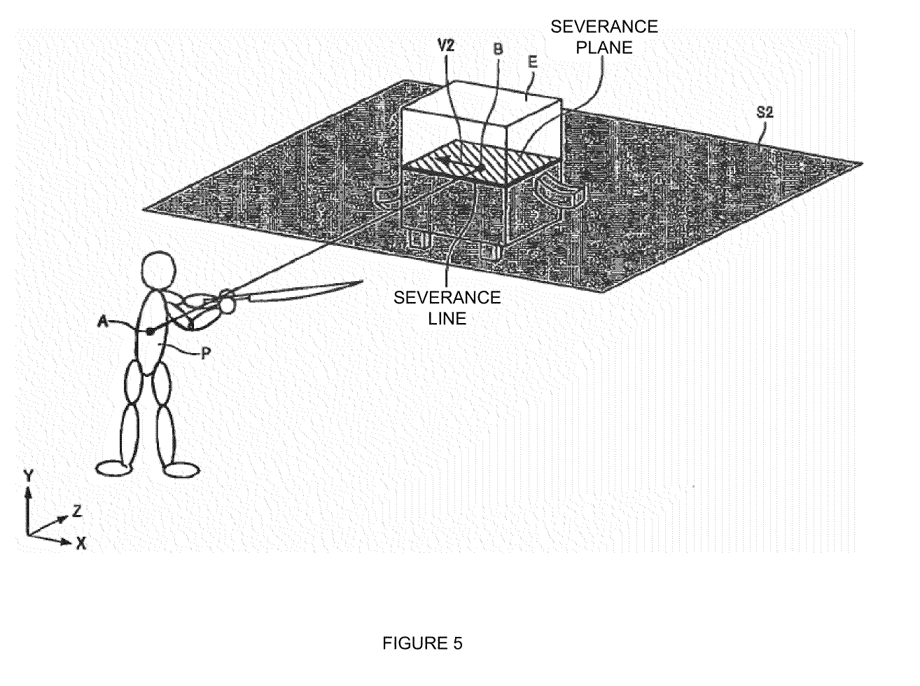

FIG. 5 illustrates the player object P, the enemy object E1, the severance line, and a severance plane during a horizontal cut attack. Upon accepting horizontal cut attack information, a horizontal attack direction V2 is defined. A virtual plane S2 is also defined, comprising representative point A of player object P, representative point B of enemy object E, and horizontal attack direction V2, and the plane where virtual plane S2 intersects with enemy object E can be determined as the severance plane. Processing can be carried out to display the set of points where enemy object E and severance plane (or virtual plane S2) intersect as a severance line.

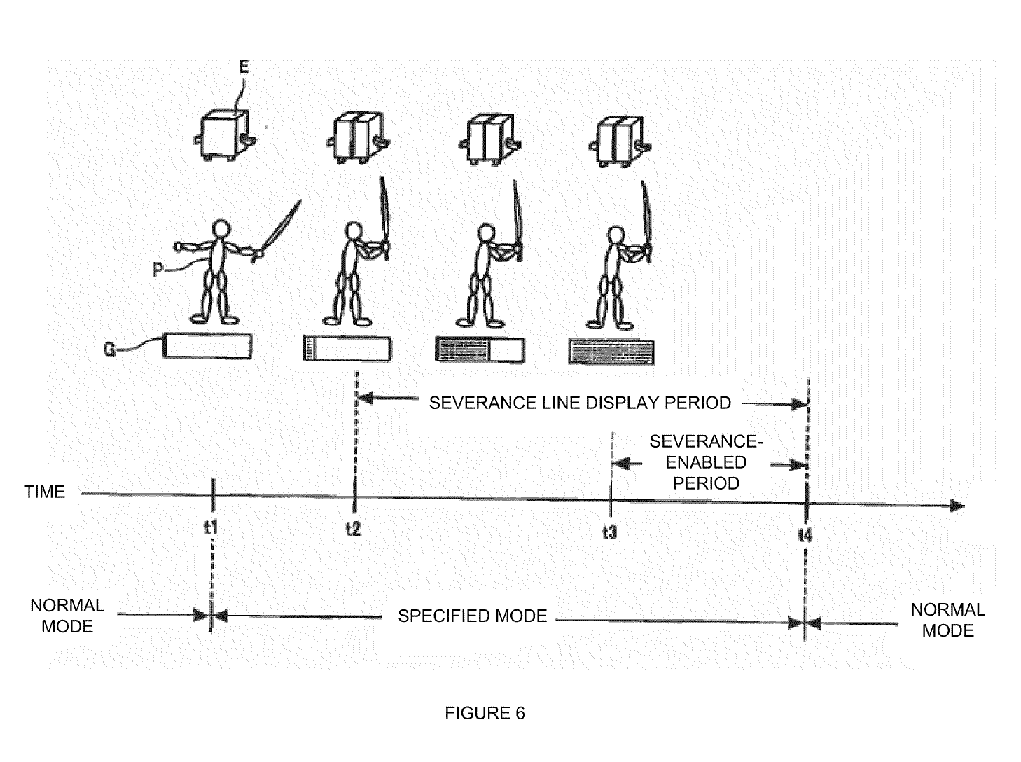

The color of the severance line of FIGS. 4 and 5 can be illustrated in a color distinct from the rest of object, allowing the player to recognize the severance line. For example, the color of the severance line can be drawn with a green fluorescent color, and the color outside the severance line can be drawn in black and white. In addition, once a severance line display period has elapsed, processing can be performed to cease display of severance lines and switch from the specified mode back to the normal mode. In one embodiment, as illustrated in FIG. 6, the severance line display period can be a predetermined period (e.g., 3 seconds) from a time point (time point t2) when attack input information was accepted from the player.

In some embodiments, it is also possible to define a severance plane and display a severance line when the enemy object has entered a specified attack range. For example, a specified attack range can be defined in advance in the object space, and when an enemy object is located within the specified attack range, processing can be carried out whereby a severance plane is defined based on the location of the player object, the location of the enemy object and the predetermined attack direction, and an enemy object severance line can then be displayed.

In addition, a severance plane can be defined and a severance line displayed in cases where the enemy object has been “locked on” to with a targeting cursor or other cursor. For example, the enemy object can been “locked on” to based on targeting or other cursor input information from the player. If it has been determined that the enemy object has been locked on to, processing can be performed where the severance plane is defined based on the location of the player object, the location of the enemy object, and a predetermined attack direction, and an enemy object severance line can then be displayed.

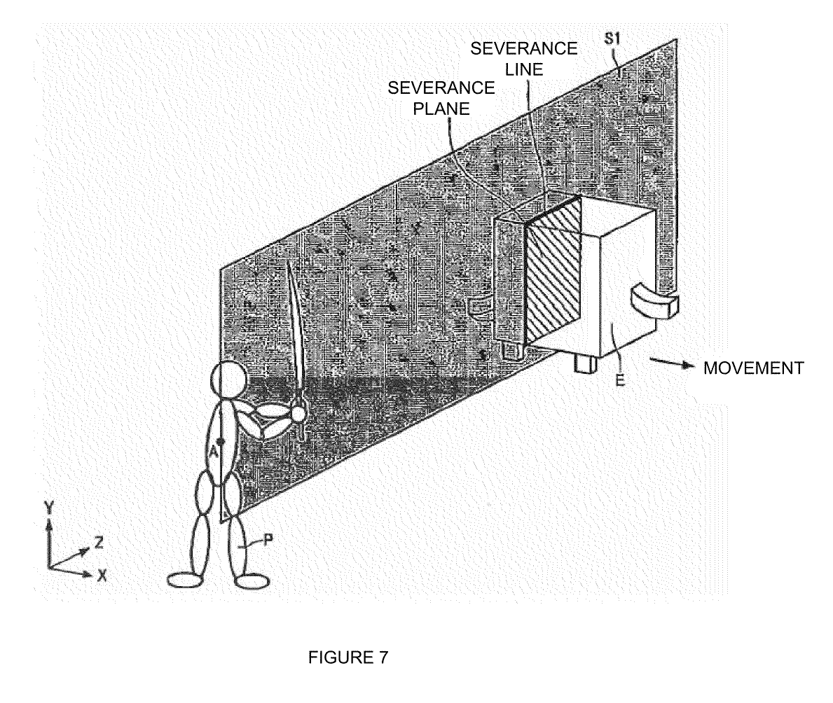

The location of the virtual plane in the object space can be determined and fixed when attack input information is accepted from the player, and subsequently, processing can be performed to modify the severance plane according to the movement and behavior of the enemy object E. For example, as shown in FIG. 7, after the location of virtual plane S1 has been determined, if the enemy object E moves to the right, the plane where virtual plane S1 and the moved enemy object E intersect is determined as the new severance plane of the enemy object E. Therefore, the severance plane and severance lines are modified and displayed according to the movement and behavior of the enemy object E. In the example of FIG. 7, when the enemy object E moves to the right (in the positive direction along the X axis), the severance plane and severance line are changed so as to move to the left of the enemy object E (in the negative direction along the X axis).

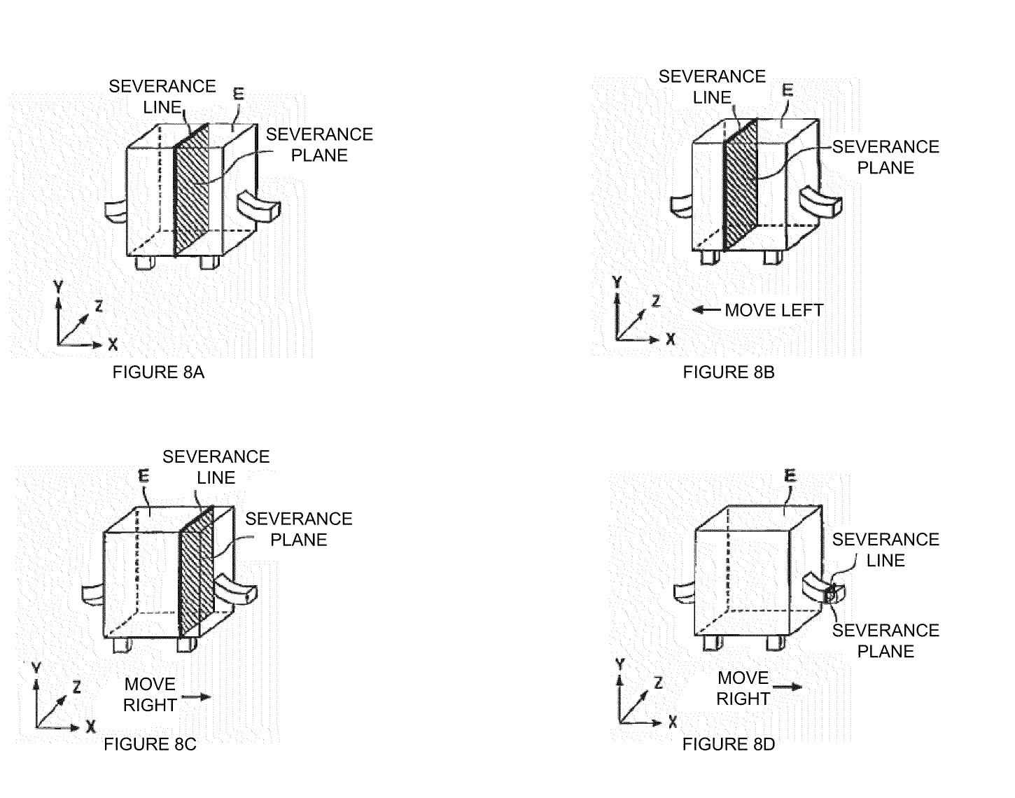

Processing can also be performed to change the severance line based on player input information. For example, as shown in FIG. 8A, when “vertical cut attack input information” is accepted, the severance line can be determined based on the severance plane passing through representative point B of enemy object E. Then, when left directional key input information is accepted from the player, as shown in FIG. 8B, processing is performed to move the severance line to the left. Furthermore, as shown in FIGS. 8C and 8D, when right directional key input information is accepted from the player, processing is performed to move the severance line to the right. Thus, processing can be performed to move the virtual plane S1 based on directional instruction input information from the player, to determine the severance plane based on the moved virtual plane S1, and to determine the severance line.

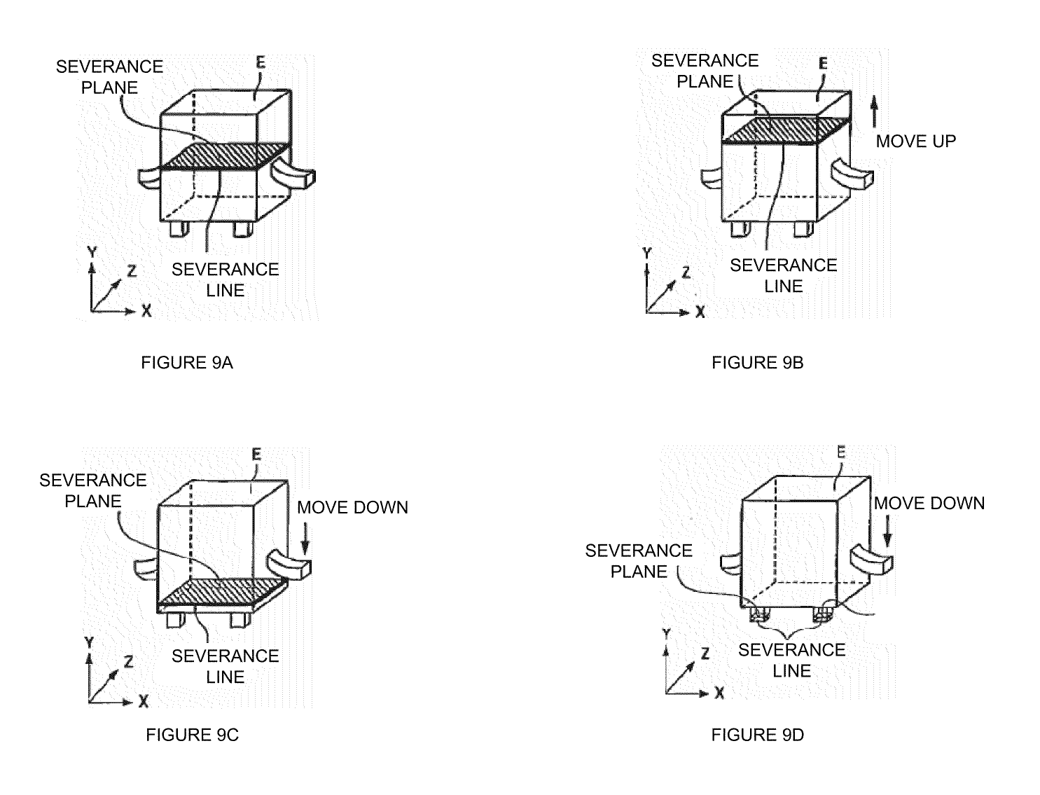

Furthermore, as shown in FIG. 9A, at the moment “horizontal cut attack input information” is accepted, the severance line can be determined based on the severance plane passing through representative point B of enemy object E. Then, when up directional key input information is accepted from the player, as shown in FIG. 9B, processing can be performed to move the severance line upward. As shown in FIGS. 9C and 9D, when down direction key input information is accepted from the player, processing is performed to move the severance line downward. Thus, processing is performed to move the virtual plane S2 based on directional instruction input information from the player, to determine the severance plane based on the moved virtual plane S2, and to determine the severance line.

As shown in FIGS. 8A-9D, severance line movement control can be performed based on directional instruction input information from the player while in the specified mode. While in the normal mode, the same directional instruction input information can be for performing movement processing of the player object. Thus, movement processing of the player object is not performed while in the specified mode. Namely, the location of the player object is not changed while in the specified mode. As a result, the player can operate the directional keys for moving the player object in the normal mode and also for moving the severance line in the specified mode.

When attack input information from the player ceases to be continuously accepted, processing can be performed to execute the motion of the player object attacking the enemy object and to sever the enemy object along the severance line. As shown in FIGS. 8A-9D, the severance plane can change in real time in accordance with the movement or behavior of an enemy object E or the operation of the player. The attack motion at the time of severance can be generated in real time so that the movement of player object P corresponding to the change in the severance plane is natural.

In some embodiments, determination (i.e., through determination processing) of whether or not the enemy object E has been severed can be based on a severance-enable period. As shown in FIG. 6, if the time when attack input information from the player ceases to be continuously accepted during a severance-enabled period (e.g., between time t3 and time t4), it is determined that the enemy object E has been severed. If the time when attack input information from the player ceases to be continuously accepted is not during a severance-enabled period, it is determined that the enemy object has not been severed.

As shown in FIG. 6, at time t1, the specified mode is entered. At time t2, when vertical cut attack input information is inputted and accepted from the player, a severance line is displayed. Processing to move the severance line can be performed based on input information from the player only for the duration of the severance line display period following time point t2. The severance-enabled period can be a predetermined period starting from the time t3 (e.g., 2 seconds after the time t2) and ending at time t4. When vertical attack input information from the player ceases to be continuously accepted during the severance-enabled period, the motion of the player object P attacking the enemy object E is executed, and the processing of splitting the enemy object E along the severance line is performed when the player object P hits the enemy object E. Once the severance-enabled period has elapsed, switching is performed from the specified mode to the normal mode. Control can also be provided whereby the player object P sustains an attack from the enemy object E at time point t4.

When not in the severance-enabled period, for example between time t2 and time t3, the processing of severing the enemy object is not performed. In other words, control can be provided such that, in the case when vertical attack input information from the player ceases to be continuously accepted is within the period t2 to t3, the motion of the player object P attacking the enemy object E will not be executed and the enemy object E will not be severed along the severance line. However, if the player object P hits the enemy object E, the processing of reducing the strength level of the enemy object E can be carried out.

FIG. 6 also shows a gauge G. The gauge G, shown as a bar graph, can be displayed for the player to recognize the severing-enable period during which the player object P can perform a severing attack against the enemy object E. As shown in FIG. 6, the displayed gauge G is set to an initial value at time t2, which is the time point when attack input information from the player is accepted. A gradually increasing value of gauge G is displayed from time t2 to time t3, and during the period between time t3 and time t4, which is the severing-enabled period, gauge G is displayed as being set to a constant value (e.g., the maximum value).

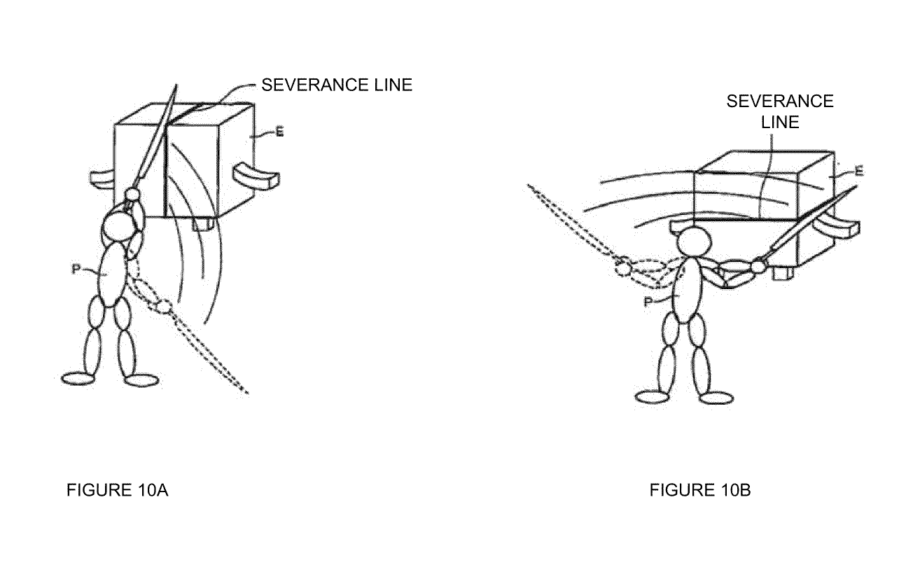

FIGS. 10A and 10B illustrate motion processing of the player object P involved in severing. FIG. 10A shows a vertical cut severing attack and FIG. 10B shows a horizontal severing attack. As shown in FIGS. 10A and 10B, motion is generated whereby the player object P attacks the enemy object E and the sword moves along the severance line. At the point in time when vertical or horizontal cut attack input information from the player ceases to be continuously accepted, a motion is generated whereby the player object P swings its sword down or across a straight line along the severance plane.

In one embodiment, the processing for determining whether the enemy object has been severed can be performed as a hit determination of the player object and the enemy object rather than a timing determination. More specifically, the processing can determine that the enemy object was severed if it determined, during the specified mode, that the player object has hit the enemy object. Conversely, the processing can determine that the enemy object was not severed if it determined that the player object has not hit the enemy object during the specified mode.

If it is determined that the enemy object has been severed, processing for generating the object after severance can be performed. As further described below, processing for generating the severed object in real time is performed by finding the vertices of multiple objects after severance (i.e., “severed objects”) based on the enemy object before severance and the severance plane. Processing is then performed to draw the severed objects in place of the enemy object at the timing at which the player object hits the enemy object. For example, FIG. 2B illustrates severed objects E1-a1 and E1-a2 in place of the enemy object E1 after severance processing.

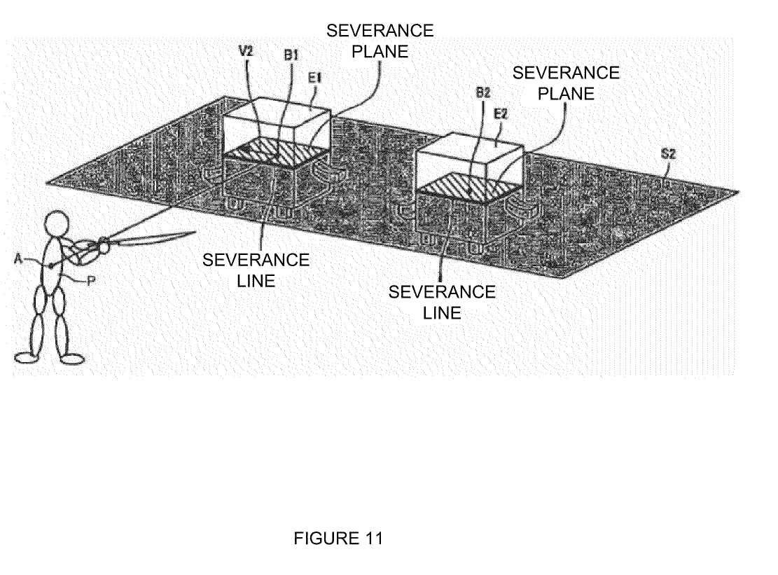

If there are multiple enemy objects present within a prescribed range, severance planes for multiple enemy objects can be set using a single virtual plane, and processing for displaying the severance lines of each enemy object can then performed. For example, FIG. 11, shows enemy objects E1 and E2 positioned within a prescribed range. When “horizontal cut attack input information” is received, a virtual plane S2 is set based on the representative point A of the player object P, the representative point B1 of enemy object E1 (or the representative point B2 of enemy object E2), and the attack direction V2. Planes intersecting with virtual plane S2 and enemy objects E1 and E2 is are set as severance planes, and the severance lines of each of the enemy objects E1 and E2 are displayed based on the severance planes. Virtual plane S2 can be moved based on direction instruction input information from the player, and the severance planes are set based on virtual plane 2 after movement. Thus, the severance lines of each of the enemy objects can be moved in real-time based on the direction instruction input information of the player.

In one embodiment, when multiple pieces of attack input information are inputted in the normal mode (i.e., multiple inputs within a prescribed amount of time), also known as “combos”, processing for changing the manner of swinging the sword according to each piece of attack input information can be performed. In one example, the player object can be operated such that, if multiple pieces of horizontal cut attack input information are inputted, the player object swings its sword in a first attack direction V1 (e.g., from diagonally above and to the right) for the Nth piece of input information, in attack direction V2 (e.g., from diagonally above and to the left) for the N+1th piece of input information, and in attack direction V3 (e.g., directly across from the right) for the N+2th piece of input information.

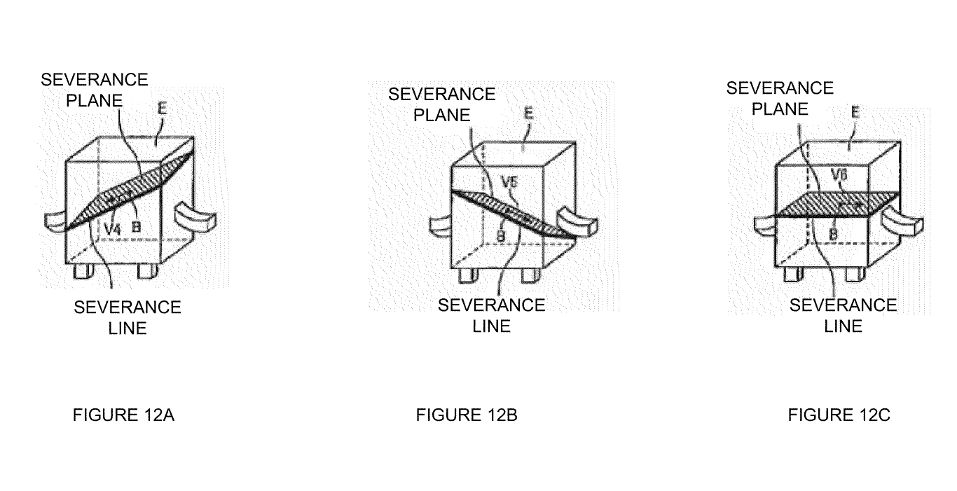

The severance planes can be set based on the manner in which the sword is swung (attack direction) corresponding to each piece of attack input information in any given mode, and the severance lines are displayed based on the severance planes. Thus, when the horizontal attack input information received the Nth time is received continuously, processing can performed whereby a severance plane is generated based on the attack direction V4, representative point A of the player object, and representative point B of enemy object E, and the severance line of enemy object E is displayed based on the severance plane, as shown in FIG. 12A. As shown in FIG. 12B, when the horizontal cut attack information received the N+1th time is received continuously while in the specified mode, processing is performed whereby a severance plane is generated based on the attack direction V5, representative point A of the player object, and representative point B of enemy object E, and a severance line is displayed for enemy object E based on the severance plane. As shown in FIG. 12C, when horizontal cut attack input information, which was accepted at number N+2 while in the specified mode, is continuously being accepted, processing is performed whereby a severance plane is generated based on the attack direction V6, representative point A of the player object, and representative point B of enemy object E, and a severance line is displayed for enemy object E based on the severance plane.

Player point calculation can be performed based on severing attacks. For example, as further described below, points can be calculated according to the size of the surface area of the severance plane at which the enemy object was severed. As a result, if the surface area of the severance plane is 10, 10 points are added, and if the surface area of the severance plane is 100, 100 points are added. For instance, the severance plane shown in FIG. 8C has a greater surface area than the severance plane shown in FIG. 8D, and thus, the severing attack in FIG. 8C will result in higher point values than with the severing attack in FIG. 8D. Also, points can be calculated based on the number of severed objects at the time of severing (e.g., if there are two severed objects, two points are added to the score, and if there are three severed objects, three points are added to the score, and so on) and points can be calculated according to the constituent part of the enemy object (e.g., five points are added to the score for arms and three points for legs).

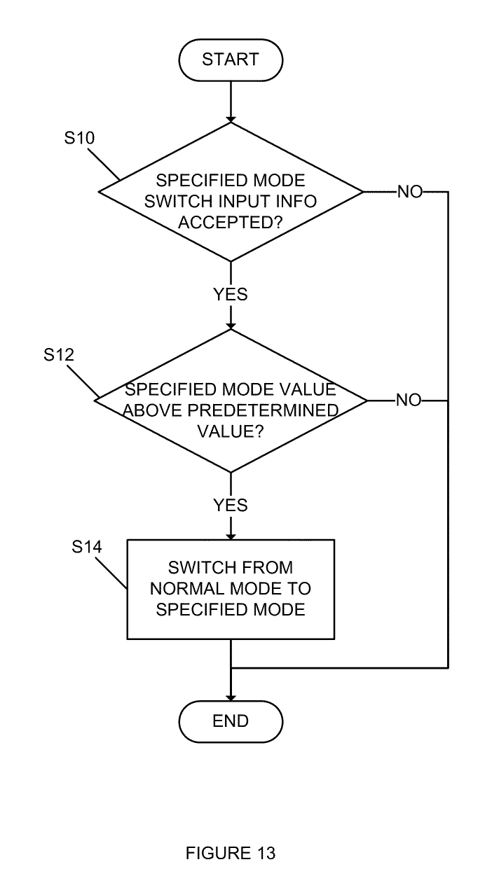

FIG. 13 is a flow chart illustrating the processing of transitioning to the specified mode. First, it can be determined if specified mode switch input information has been accepted at step S10. If specified mode switch input information has been accepted, it can then be determined if the specified mode value is at or above a predetermined value at step S12. Next, if the specified mode value is at or above a predetermined value, processing can be performed to switch from the normal mode to the specified mode at step S14. If specified mode switch input information has not been accepted at step S10 or if the specified mode value is not at or above a predetermined value at step S12, the processing can be terminated and the game can continue in the normal mode.

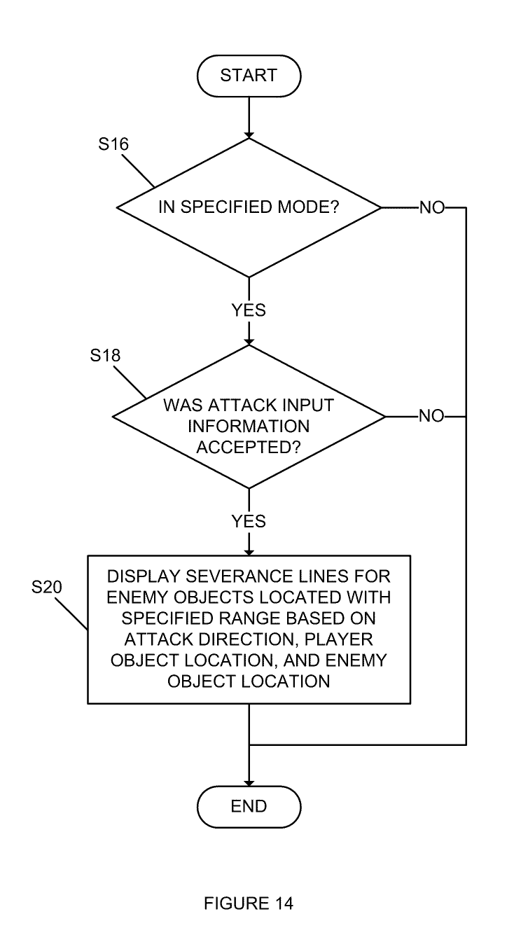

FIG. 14 is a flow chart of the processing relating to displaying the severance line. First, it is determined if the player is in the specified mode at step S16. If in the specified mode, it is determined if the attack input information has been received at step S18. Next, if the attack input information has been received, the severance line for an object located in a specified area based on the attack direction, the position of the player object, and the position of the enemy object is displayed at step S20.

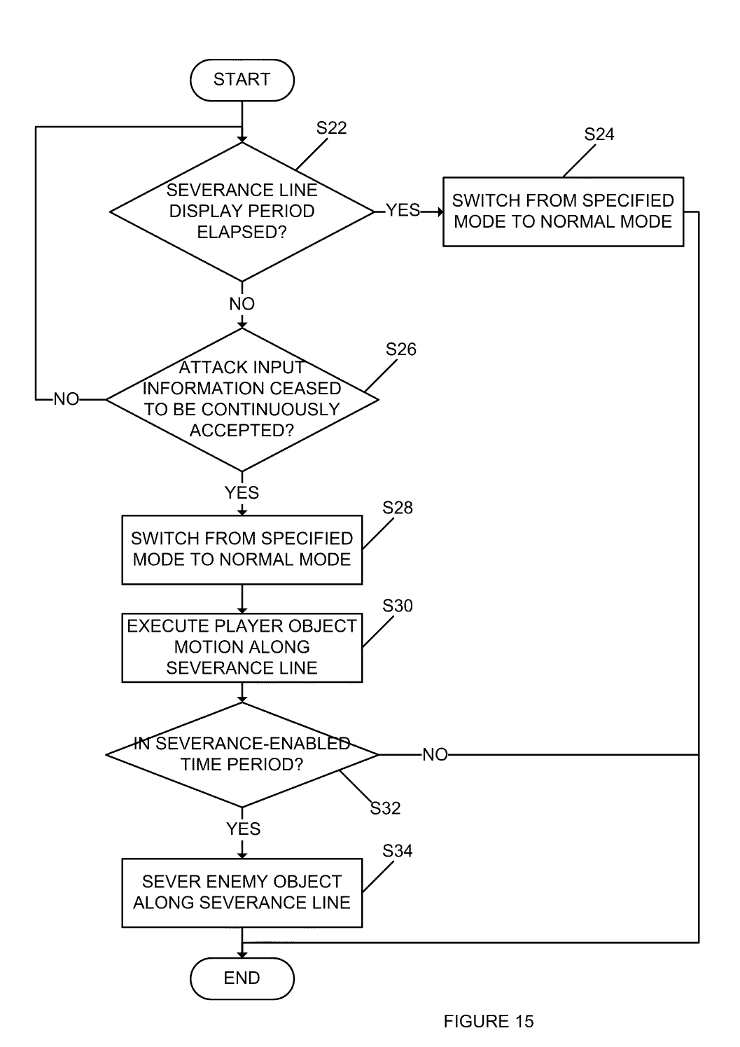

FIG. 15 is a flow chart of the processing relating to severance processing. First, it is determined if the severance line display period has elapsed at step S22. If the severance line display period has elapsed, processing is performed to switch from the specified mode to the normal mode at step S24 and the processing is terminated. If the severance line display period has not elapsed (at step S22), it is determined if attack input information is no longer continuously being accepted at step S26. If attack input information is still continuously being accepted, the process is looped back to step S22. If attack input information is not continuously being accepted, the processing of switching from the specified mode to the normal mode is performed at step S28, and the player object's motion along the severance line is executed at step S30. Next, it is determined if the time point when attack input information ceases to be continuously accepted is within the severance-enabled period at step S32. If the time point when attack input information ceases to be continuously accepted is within the severance-enabled period, processing is performed to sever the enemy object along the severance line at step S34. If the time point when attack input information ceases to be continuously accepted is not within the severance-enabled period, processing is terminated.

In some embodiments, severance processing can be carried out on various types of objects as well as enemy objects. Furthermore, severance lines can be displayed according to the type of object. For example, for objects which by nature can be cut (trees, robots, fish, birds, mammals, etc.), a severance plane can be defined and a severance line is displayed. Objects such as stone objects or cloud objects, which by nature cannot be cut, can be treated as not being subject to severance processing, and control can be provided such that no severance planes are defined and no severance lines are displayed for such objects.

Severance processing can also be based on different regions of an enemy object. For example, enemy objects can have non-severable regions and control can be provided to avoid the non-severable regions when displaying severance lines. In one example, if the enemy object is wearing armor on its torso, the area covered with armor can be defined as a non-severable region and control can be provided to define a severance plane and display a severance line on the enemy object while avoiding the portion that is covered with armor.

In addition, control can be provided to display severance lines according to the type of weapon the player object is using. For example, if the weapon is a boomerang, control can be provided such that the severance plane and the severance line are always defined horizontally. Also, if the weapon is sharp, such as a sword, an axe, or a boomerang, it can be treated as a weapon subject to severance processing as described above. If the weapon is a blunt instrument, such as a club, it may not be subject to severance processing, and control can be provided such that no severance planes are defined and no severance lines are displayed for such weapons.

Weapons can also have specific attack directions. As a result, control can be provided so as not to perform severance processing in directions other than the specific attack directions. For example, if the weapon's specific attack direction is upward (i.e., in the increasing Y axis direction), control can be provided such that no severance planes are defined and no severance lines are displayed when the weapon is used for horizontal hits.

In some embodiments of the invention, the game system 10 can provide processing to detect if body parts of a player object or an enemy object have been severed. The objects can have virtual skeletal structures with bones and joints, or representative points and connecting lines, and the locations of one or more of these components of the objects can be used to determine whether the objects have been severed.

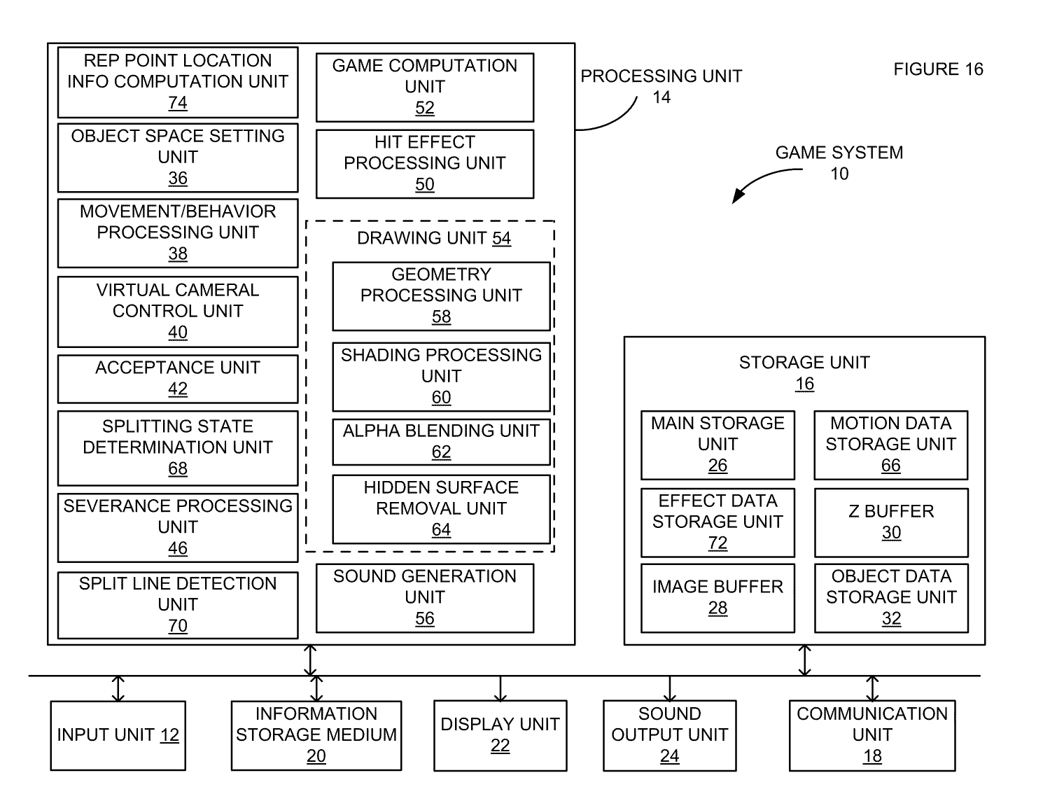

FIG. 16 illustrates the game system 10 including additional components to carry out the evaluation of body parts being severed. These additional components, although not shown, can also be included in the game system illustrated in FIG. 1.

The game system of FIG. 16 can include at least the input unit 12, the processing unit 14, the storage unit 16, the communication unit 18, the information storage medium 20, the display unit 22, the sound output unit 24, the main storage unit 26, the image buffer 28, the Z buffer 30, the object data storage unit 32, the object space setting unit 36, the movement and behavior processing unit 38, the virtual camera control unit 40, the acceptance unit 42, the severance processing unit 46, the hit effect processing unit 50, the game computation unit 52, the drawing unit 54, the sound generation unit 56, the geometry processing unit 58, the shading processing unit 60, the α blending unit 62, and the hidden surface removal unit 64.

The game system of FIG. 16 can also include a motion data storage unit 66, a splitting state determination unit 68, a split line detection unit 70, an effect data storage unit 72, and a representative point location information computation unit 74.

The motion data storage unit 66 can store motion data used for motion processing by the movement and behavior processing unit 38. More specifically, the motion data storage unit 66 can store motion data including the location or angle of rotation of bones, or part objects, which form the skeleton of a model object. The angle of rotation can be about three axes of a child bone in relation to a parent bone, as described below. The movement and behavior processing unit 38 can read this motion data and reproduce the motion of the model object by moving (i.e., deforming the skeleton structure) of the bones making up the skeleton of the model object based on the read motion data.

The splitting state determination unit 68 can determine the splitting state of objects (presence/absence of splitting, split part, etc.) based on location information of bones or representative points of a model object. The split line detection unit 70 can set virtual lines connecting representative points, can detect lines split by severance processing, and can retain split line information for specifying the lines which have been split.

The effect data storage unit 72 can store effect elements (e.g. objects used for effects, textures used for effects) with different patterns in association with splitting states. The hit effect processing unit 50 can select corresponding effect elements based on the severance states and perform processing generate images using the selected effect element.

The following paragraphs describe execution of the game system 10, according to one embodiment of the invention, to carry out the evaluation of body parts being severed.

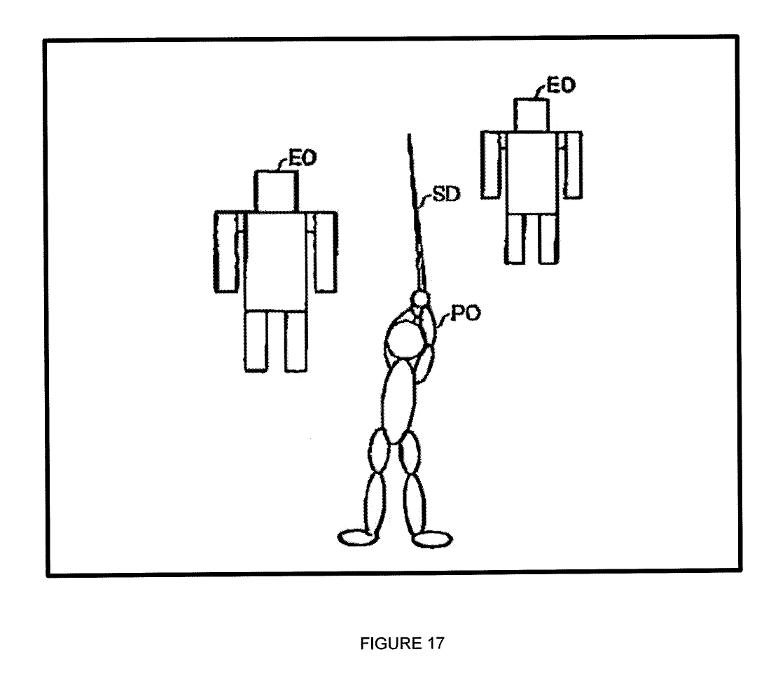

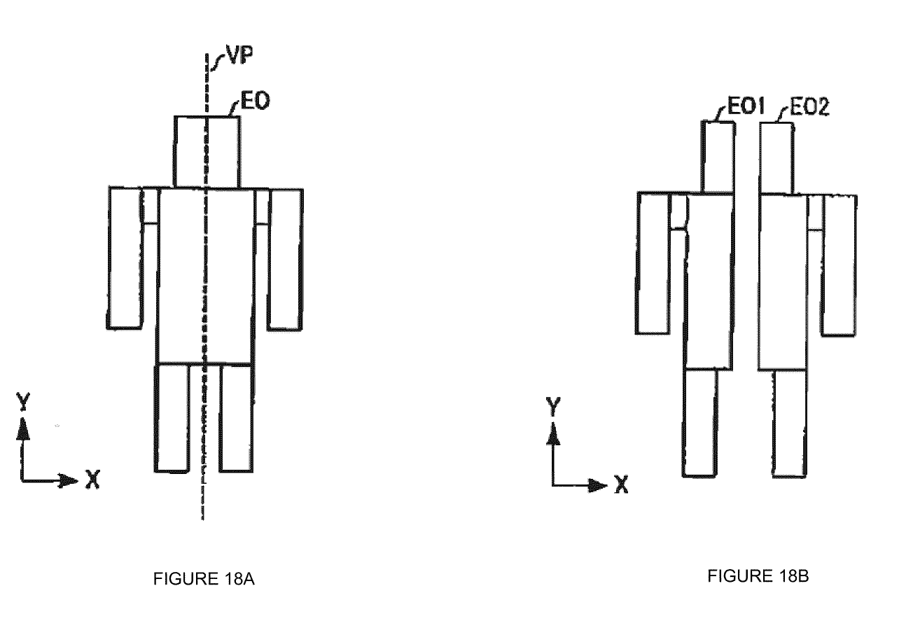

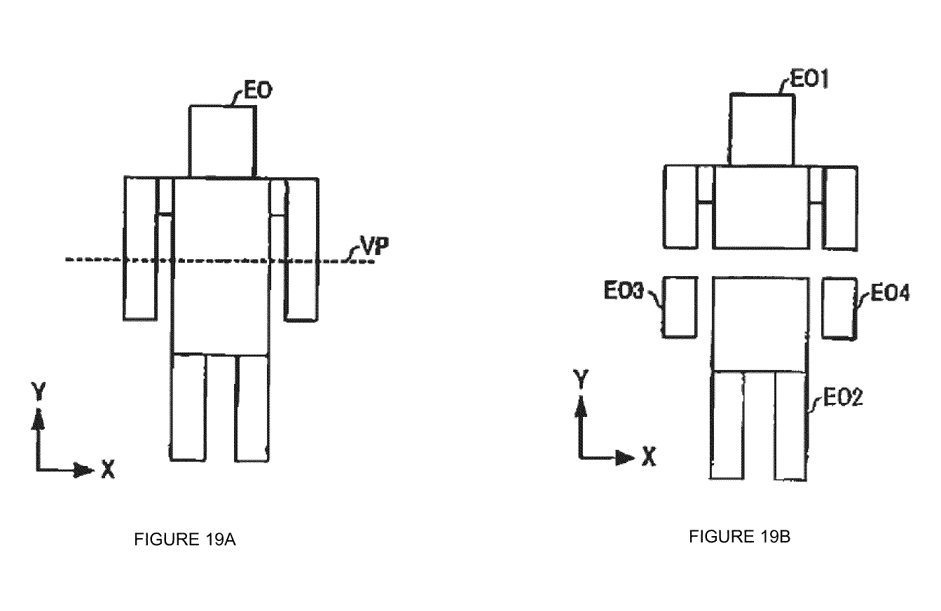

FIG. 17 is an example display of a game image according to one embodiment of the invention. As described above, upon accepting “vertical cut attack input information,” processing can be performed whereby, as shown in FIG. 18A, a virtual plane VP is defined parallel to the vertical direction (Y axis direction) in relation to the enemy object EO that is the target of attack, and, as shown in FIG. 18B, the enemy object EO is separated into multiple objects EO1 and EO2 along the boundary of virtual plane VP. Furthermore, when “horizontal cut attack input information” is accepted, processing can be performed whereby, as shown in FIG. 19A, a virtual plane VP is defined parallel to the horizontal direction (X axis direction), in relation to the enemy object EO that is the target of attack, and, as shown in FIG. 19B, the enemy object EO is separated into multiple objects EO1 through EO4 along the boundary of virtual plane VP.

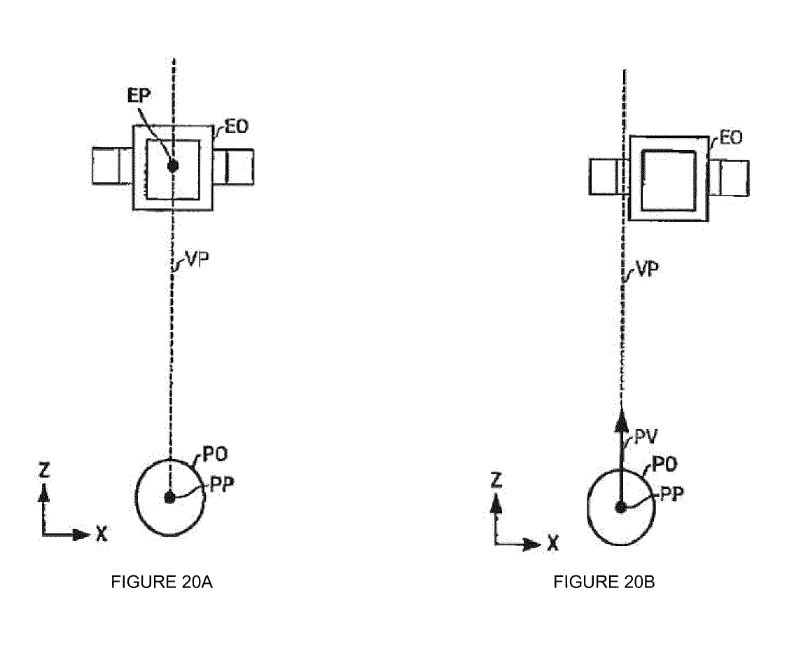

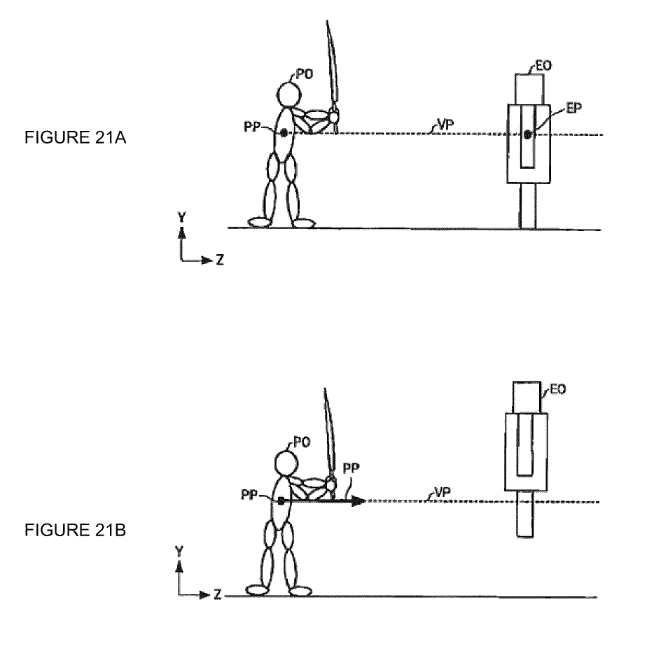

More specifically, when “vertical cut attack input information” is accepted, as shown FIG. 20A, a virtual plane VP is defined parallel to the vertical direction (Y axis direction), containing the line which passes through representative point PP of the player object PO and representative point EP of the enemy object EO. Also, as shown in FIG. 20B, the virtual plane VP can be defined parallel to the vertical direction (Y axis direction) extending in the direction PV (based on the enemy object movement direction) of the player object PO. Similarly, when “horizontal cut attack input information” is accepted, as shown FIG. 21A, a virtual plane VP is defined parallel to the horizontal direction (X axis direction), containing the line which passes through representative point PP of the player object PO and representative point EP of the enemy object EO. Furthermore, as shown in FIG. 21B, the virtual plane VP can be defined parallel to the horizontal direction (X axis direction) extending in the direction PV (based on the enemy object movement direction) of the player object PO.

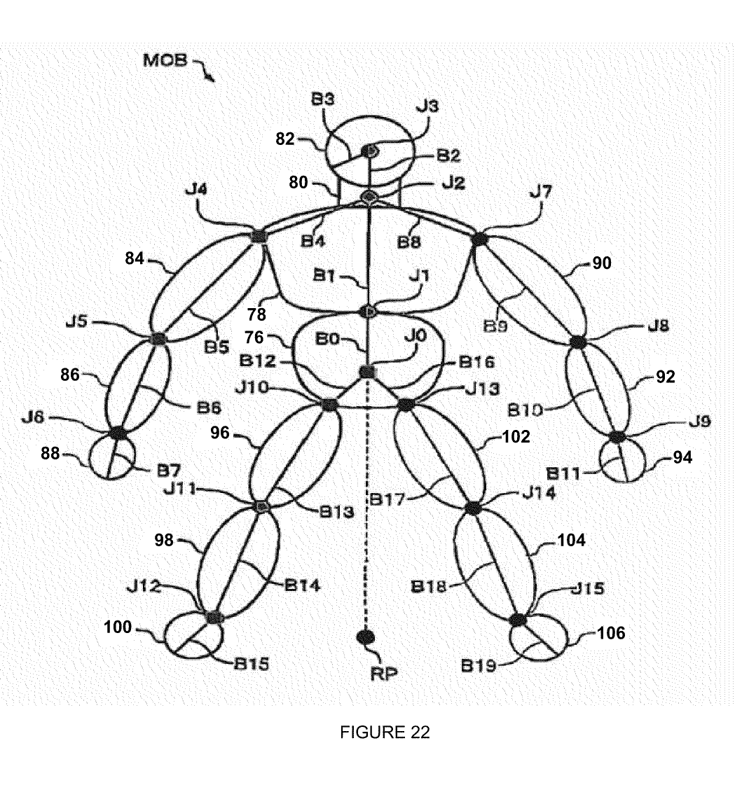

FIG. 22 illustrates a model object MOB, that can be subjected to splitting, or being severed. As shown in FIG. 22, the model object MOB can be composed of multiple part objects: hips 76, chest 78, neck 80, head 82, right upper arm 84, right forearm 86, right hand 88, left upper arm 90, left forearm 92, left hand 94, right thigh 96, right shin 98, right foot 100, left thigh 102, left shin 104, left foot 106. The part objects can be characterized by a skeletal model comprising bones B0-B19 and joints J0-J15. The bones B0-B19 and the joints J0-J15 can be a virtual skeletal model inside the part objects and not actually displayed.

The bones making up the skeleton of a model object MOB can have a parent-child, or hierarchical, structure. For example, the parents of the bones B7 and B11 of the hands 88 and 94 can be the bones B6 and B10 of the forearms 86 and 92, and the parents of B6 and B10 are the bones B5 and B9 of the upper arms 84 and 90. Furthermore, the parent of B5 and B9 is the bone B1 of the chest 78, and the parent of B1 is the bone B0 of the hips 76. The parents of the bones B15 and B19 of the feet 100 and 106 are the bones B14 and B18 of the shins 98 and 104, the parents of B14 and B18 are the bones B13 and B17 of the thighs 96 and 102, and the parents of B13 and B17 are the bones B12 and B16 of the hips 76. In addition to bones B1-B19 of FIG. 22, auxiliary bones which assist the deformation of the model object MOB can be included in some embodiments.

The location and angle of rotation (e.g., direction) of the part objects 76-106 can be specified by the location (e.g., of the joints J0-J15 and/or bones B0-B19) and the angle of rotation of the bones B0-B19 (for example, the angles of rotation α, β, and γ about the X axis, Y axis, and Z axis, respectively of a child bone in relation to a parent bone). The location and angle of rotation of the part objects can be stored as motion data in motion data storage unit 66. In one embodiment, only the bone angle of rotation is included in the motion data and the joint location is included in the model data of the model object MOB. For example, walking motion can consist of reference motions M0, M1, M2 . . . MN (i.e., as motions in individual frames). The location and angle of rotation of each bone B0-B19 for each of these reference motions M0, M1, M2, . . . MN can then be stored in advance as motion data. The location and angle of rotation of each part object 76-106 for reference motion MO can be read, followed by the location and angle of rotation of each part object 76-106 for reference motion M1 being read, and so forth, sequentially reading the motion data of reference motions with the passage of time to implement motion processing (i.e., motion reproduction).

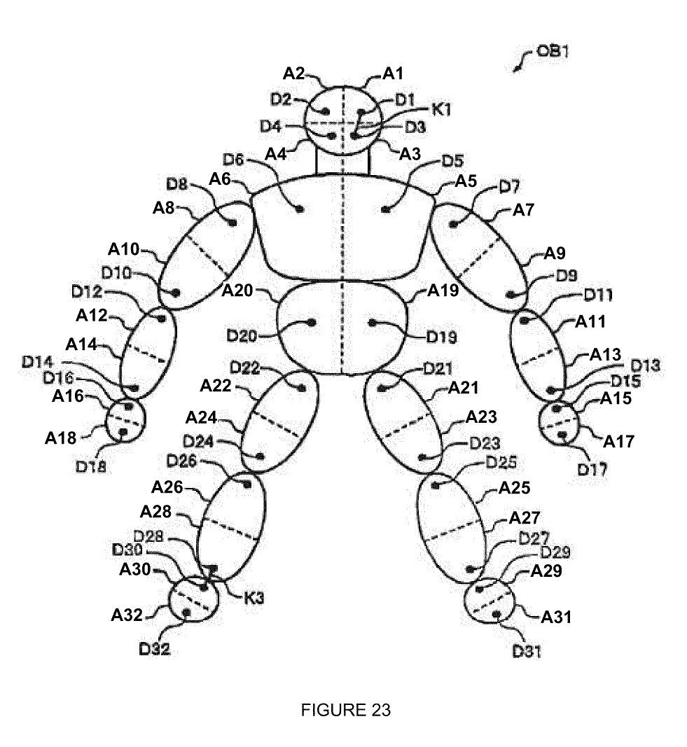

Also shown in FIG. 22 is RP, a representative point of the model object MOB. The representative point RP can be defined, for example, at a location directly below the hip joint J0 (e.g., the location of height zero). RP can be used for defining the location coordinates of the model object MOB. In some embodiments, multiple representative points can be defined on an object, and representative point location information computation processing can performed to compute the location information (location coordinates, etc.) of the representative points based on input information. For example, FIG. 23 illustrates multiple representative points D1-D32 defined on an object according to one embodiment of the invention. The representative points D1-D32 can be defined in association with each of the multiple parts making up the object (with at least one representative point per part), and can be used for ascertaining the locations of the individual parts of the object.

As shown in FIG. 23, the representative points D1-D4 are representative points defined in association with the head region of an object. The head region of the object can be partitioned into four virtual parts A1 through A4 (part A1 is the part near the left eye, part A2 is the part near the left eye, part A3 is the part near the left side of the mouth, and part A4 is the part near the right side of the mouth), with the representative points D1 through D4 being associated with the respective parts A1 through A4.

The representative points D5 and D6 are representative points defined in association with the chest region of the object. The chest region of the object may be partitioned into two virtual parts A5, A6 (part A5 being the part near the left side of the chest, and part A6 being the part near the right side of the chest), with representative points D5 and D6 being associated with the respective parts A5 and A6.

The representative points D7, D9 are representative points defined in association with the left upper arm region of the object. The left upper arm region of the object may be partitioned into two virtual parts A7 and A9 (part A7 being the part near the upper portion of the left upper arm, and part A9 being the part near the lower portion of the left upper arm), with representative points D7 and D9 being associated with the respective parts A7 and A9.

The representative points D8 and D10 are representative points defined in association with the right upper arm region of the object. The right upper arm region of the object may be partitioned into two virtual parts A8 and A10 (part A8 being the part near the upper portion of the right upper arm, and part A10 being the part near the lower portion of the right upper arm), with representative points D8 and D10 being associated with the respective parts A8 and A10.

The representative points D11 and D13 are representative points defined in association with the left forearm region of the object. The left forearm region of the object may be partitioned into two virtual parts A11 and A13 (part A11 being the part near the upper portion of the left forearm, and part A13 being the part near the lower portion of the left forearm), with representative points D11 and D13 being associated with the respective parts A11 and A13.

The representative points D12 and D14 are representative points defined in association with the right forearm region of the object. The right forearm region of the object may be partitioned into two virtual parts A12 and A14 (part A12 being the part near the upper portion of the right forearm, and part A14 being the part near the lower portion of the right forearm), with representative points D12, D14 being associated with the respective parts A12 and A14.

The representative points D15 and D17 are representative points defined in association with the left hand region of the object. The left hand region of the object may be partitioned into two virtual parts A15, A17 (part A15 being the part near the upper portion of the left hand, and part A17 being the part near the lower portion of the left hand), with representative points D15 and D17 being associated with the respective parts A15 and A17.

The representative points D16 and D18 are representative points defined in association with the right hand region of the object. The right hand region of the object may be partitioned into two virtual parts A16 and A18 (part A16 being the part near the upper portion of the right hand, and part A18 being the part near the lower portion of the right hand), with representative points D16 and D18 being associated with the respective parts A16 and A18.

The representative points D19 and D20 are representative points defined in association with the hip region of the object. The hip region of the object may be partitioned into two virtual parts A19 and A20 (part A19 being a part near the hip region, and part A20 being a part near the hip region), with representative points D19 and D20 being associated with the respective parts A19 and A20.

The representative points D21 and D23 are representative points defined in association with the left thigh region of the object. The left thigh region of the object may be partitioned into two virtual parts A21 and A23 (part A23 being the part near the upper portion of the left thigh, and part A23 being the part near the lower portion of the left thigh), with representative points D21 and D23 being associated with the respective parts A21 and A23.

The representative points D22 and D24 are representative points defined in association with the right thigh region of the object. The right thigh region of the object may be partitioned into two virtual parts A22 and A24 (part A22 being the part near the upper portion of the right thigh, and part A24 being the part near the lower portion of the right thigh), with representative points D22 and D24 being associated with the respective parts A22 and A24.

The representative points D25 and D27 are representative points defined in association with the left shin region of the object. The left shin region of the object may be partitioned into two virtual parts A25 and A27 (part A25 being the part near the upper portion of the left shin, and part A27 being the part near the lower portion of the left shin), with representative points D25 and D27 being associated with the respective parts A25 and A27.

The representative points D26 and D28 are representative points defined in association with the right shin region of the object. The right shin region of the object may be partitioned into two virtual parts A26 and A28 (part A26 being the part near the upper portion of the left shin, and part A28 being the part near the lower portion of the left shin), with representative points D26 and D28 being associated with the respective parts A26 and A28.

The representative points D29 and D31 are representative points defined in association with the left foot region of the object. The left foot region of the object may be partitioned into two virtual parts A29 and A31 (part A29 being the part near the upper portion of the left foot, and part A31 being the part near the lower portion of the left foot), with representative points D29 and D31 being associated with the respective parts A29 and A31.

The representative points D30 and D32 are representative points defined in association with the right foot region of the object. The right foot region of the object may be partitioned into two virtual parts A30 and A32 (part A30 being the part near the upper portion of the right foot, and part A32 being the part near the lower portion of the right foot), with representative points D30 and D32 being associated with the respective parts A30 and A32.

The representative points D1-D32 can also be defined for instance as model information associated with the locations of bones B0-B19 and/or joints J0-J15 making up the skeleton model of FIG. 22. In addition, joints J0-J15 can be used as representative points. Also, when performing per-frame object location and motion computations, the location coordinates of each representative point can be computed based on object location information and location information of bones B0-B19 and/or joints J0-J15.

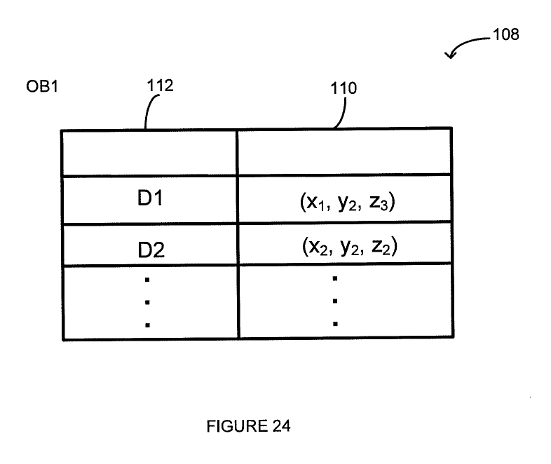

FIG. 24 illustrates a table of object information 108. The object information 108 can include location information 110 of representative points 112. In some embodiments, the object information is computed and grouped on a per-frame basis so long as an object exists, regardless of whether or not it has already been split. The location information 108 can be location coordinates of a world coordinate system, or location coordinates of a local coordinate system of a given object. In addition, location information of multiple representative points defined in multiple split sub-objects can be computed after splitting of the object. In embodiments where location coordinates in a local coordinate system of the given object are used, location coordinates in the same local coordinate system can be used when the object is split into multiple sub-objects. For example, location coordinates in a local coordinate system of the object before splitting can be used after splitting as well, or location coordinates in a local coordinate system of one of the sub-objects after splitting can be used. Furthermore, location information of representative points after an object has been split can be managed in association with the new split objects to which the representative points belong or in association with a main object after splitting (e.g. the object corresponding to the main body after splitting). Location information of representative points can be grouped on a per-frame basis.

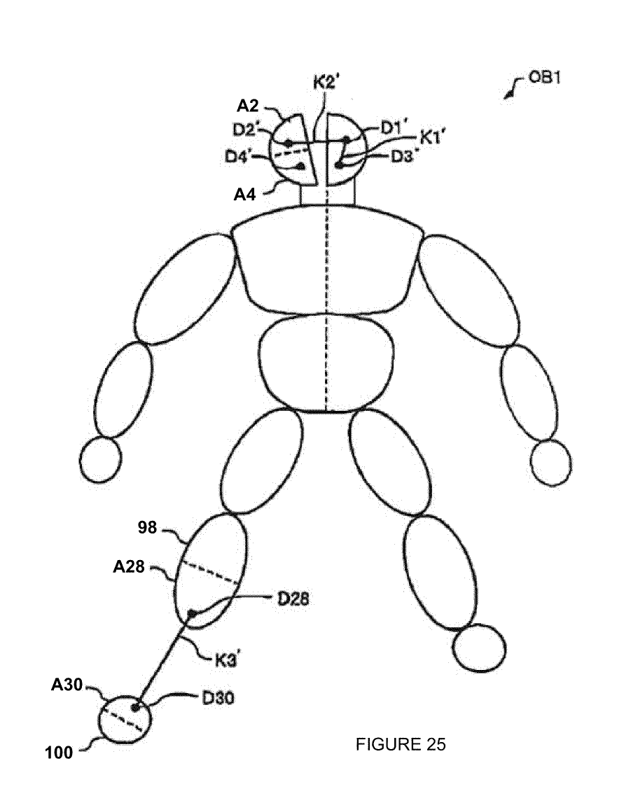

In some embodiments of the invention, the splitting state (e.g., presence/absence of splitting, split part, etc.) of an object is determined based on location information of representative points. FIG. 25 illustrates the change in distance between representative points when an object OB1 (i.e., the complete object OB1 of FIG. 23) is split. As shown in FIG. 25, the right portion of the head region of object OB1 has been split. Here, the distance KI′ between representative point D1′ and representative point D3′ after splitting is the same as the distance K1 between representative point D1′ and representative point D3′ before splitting. However, the distance L2 between representative point D1′ and representative point D2′ after splitting is longer than the distance K2 between representative point D1 and representative point D2 before splitting. Since representative point D1 and representative point D3 are representative points defined in the same part of the same joint, without splitting, their distance will be a constant K1. Therefore, if the distance between representative point D1 and representative point D3 computed in a given frame is greater than K1, it can be determined that part A1 (the part to which representative point D1 belongs, as shown in FIG. 23) and A3 (the part to which representative point D3 belongs) have been split.

As shown in FIG. 25, right foot region 100 of object OB1 has been split from right shin region 98. In this case, the distance K3′ between representative point D28′ and representative point D30′ after splitting is longer than the distance K3 between representative point D28 and representative point D30 before splitting. Here, representative point D28 and representative point D30 are representative points defined in different parts of different joints.

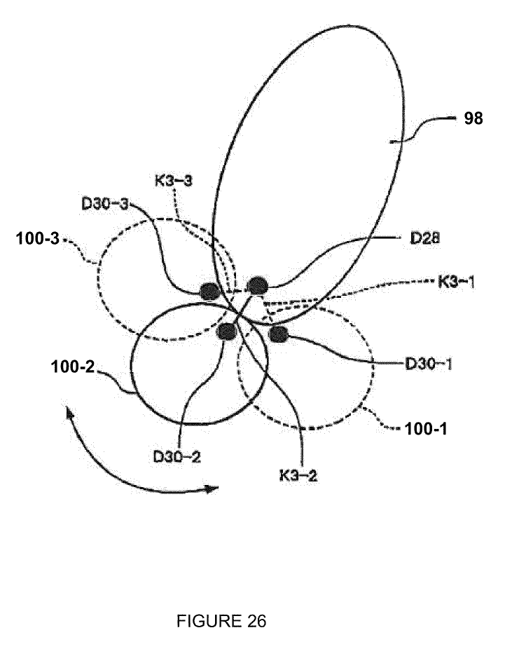

FIG. 26 illustrates the positional relationship between representative point D28 and representative point D30. Since the right foot region 100 and right shin region 98 are connected by an unillustrated joint, the positional relationship between right foot region 100 and right shin region 98 can change. For example, the right foot region 100 can take on various positional relationships with respect to the right shin region 98, as shown by positions 100-1, 100-2, and 100-3. As a result, the distance between representative point D28 and representative point D30 can change from K3-1, to K3-2, to K3-3. It can be determined that that part A28 (the part to which representative point D28 belongs, as shown in FIG. 23) and A30 (the part to which representative point D30 belongs) have been split if the distance between representative point D28 and representative point D30 has become greater than a pre-determined distance K3-max, where K3-max is the maximum value to which the distance can change.

In some embodiments, virtual lines linking representative points can be defined, and a line split can be detected (e.g., as determined by the splitting state detection unit 70). Split line information for identifying the split line can be retained and the splitting state of the object can be determined based on the split line information.

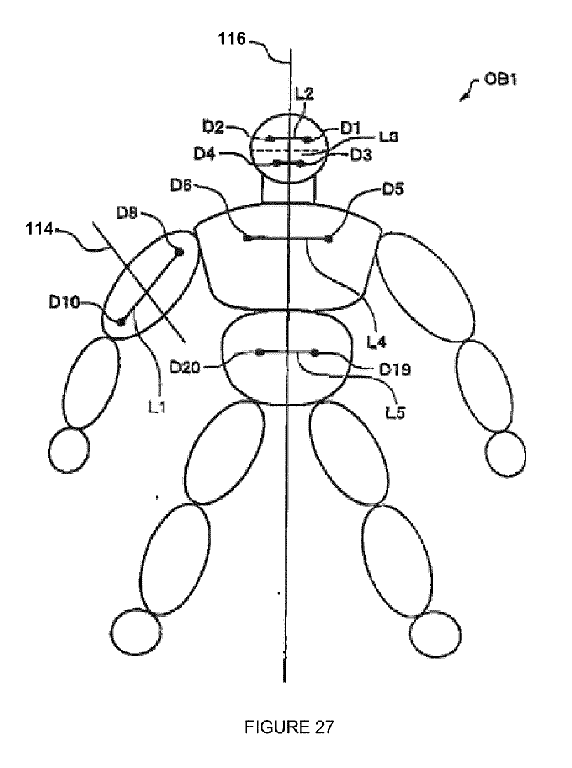

FIG. 27 illustrates virtual lines defined between representative points and the detection of split lines when an object OB1 (e.g., object OB1 from FIG. 23) has been split. As shown FIG. 27, when object OB1 is split along a first virtual plane 114, the virtual line L1 connecting representative point D8 and representative point D10 is split. Furthermore, as shown FIG. 27, when object OB1 is split along a second virtual plane 116, virtual line L2 connecting representative point D1 and representative point D2, virtual line L3 connecting representative point D3 and representative point D4, virtual line L4 connecting representative point D5 and representative point D6, and virtual line L5 connecting representative point D19 and representative point D20 are split.

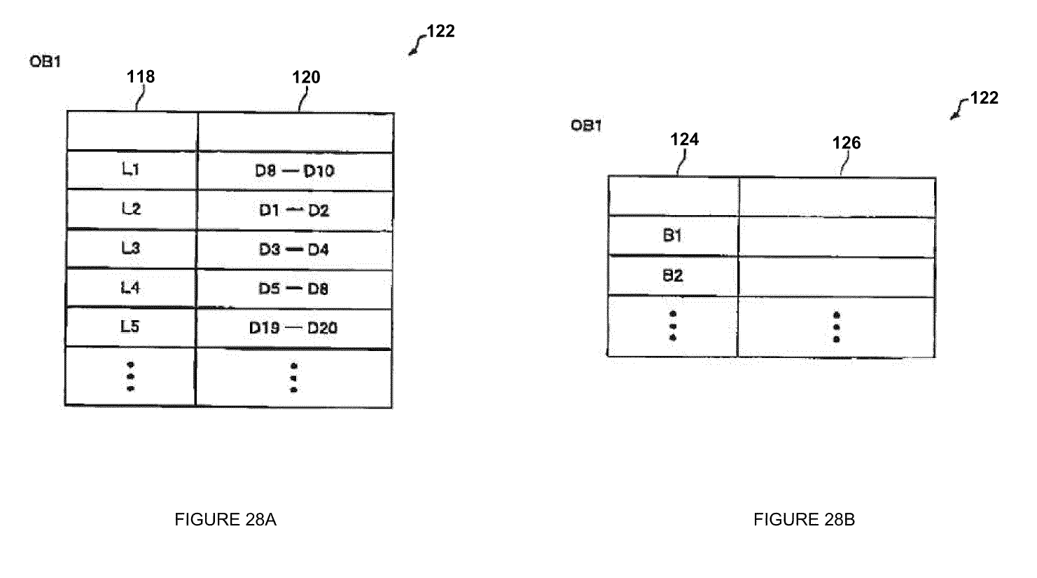

The lines split by splitting processing can be detected based on the positional relationship of the virtual plane used for splitting. The virtual plane can be defined based on input information and location information of representative points at the time of splitting. Split line information for identifying the split line can also be retained. For example, as shown in FIG. 28A, the split line ID 118 and representative point information 120 corresponding to that line (the representative point ID corresponding to the end point of the line before splitting) can be stored as split line information 122 in association with the object OB1. By doing this, the splitting state of an object at any time after splitting can be determined by referencing the split line information 122.

In one embodiment, if the joints J1415 in FIG. 22 can be treated as representative points and bones B1-B19 can be treated as virtual lines connecting the representative points, information on split bones can be stored as split line information. In this case, as shown in FIG. 28B, bone ID 124 and a splitting flag 126 indicating the presence or absence of splitting of the bone in question can be stored as split line information 122.

In some embodiments, motion data of different patterns can be stored in association with splitting states. The corresponding motion data can be selected based on the splitting state and image generation can be performed using the selected motion data.

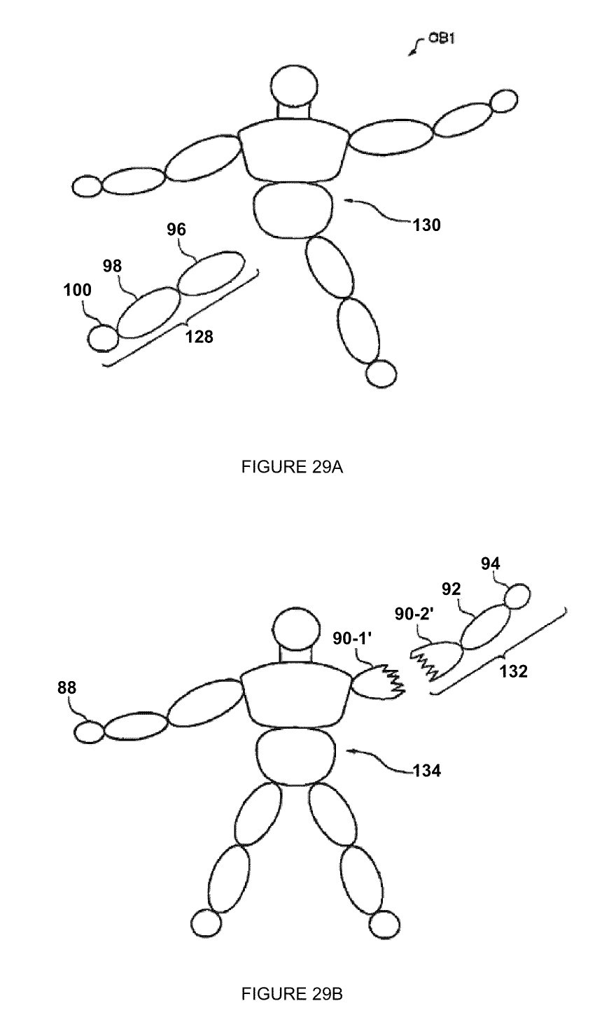

FIGS. 29A and 29B illustrate different examples of splitting states of the object OB1. FIG. 29A illustrates a state (e.g., a first splitting state) where the object OB1 is split into a first portion 128 containing right thigh 96, right shin 98, and right foot 100, and a second portion 130 containing the rest. After splitting, the first portion 120 can become the first sub-object and the second portion 130 can become the second sub-object, each of which is a separate object which moves and behaves independently. FIG. 29B illustrates a state (e.g., a second splitting state) where the object OB1 has been split into a third portion 132 containing the lower part of the left upper arm 90, the left forearm region 92 and the left hand region 94, and a fourth portion 134 containing the rest. The third portion 132 after splitting can become a third sub-object and the fourth portion 134 can become a fourth sub-object, each of which is a separate object that can move and act independently. In the cases illustrated in FIGS. 29A and 29B, the second sub-object and the fourth sub-object after splitting are split in different areas, so the motion data used can be different.

Multiple types of motion data can be provided according to the area which is split in order to make the objects act differently depending on which area they were split in. For example, if the head region has been split, providing a first splitting state, motion data md1 can be used to represent the behavior of the main body (i.e., the portion other than the head). If the right arm has been split, providing a second splitting state, motion data md2 can be used to represent the behavior of the main body (i.e., the portion other than the right arm). If the left arm has been split, providing a third splitting state, motion data md3 can be used to represent the behavior of the main body (i.e., the portion other than the left arm). If the right foot has been split, providing a fourth splitting state, motion data md4 can be used to represent the behavior of the main body (i.e., the portion other than the right foot). If the left foot has been split, providing a fifth splitting state, motion data md5 can be used to represent the behavior of the main body (i.e., the portion other than the left foot).

Therefore, in the case of FIG. 29A, which would be the fourth splitting state described above, motion data md4 would be selected for the motion of the second sub-object 130. Furthermore, in the case of FIG. 29B, which would be the third splitting state described above, motion data md3 would be selected for the motion of the fourth sub-object 134.

Effect selections can also be determined according to splitting state in some embodiments. For example, if the enemy object EO has been severed due to an attack by the player object, an effect display representing the damage sustained by the enemy object EO is drawn in association with the enemy object. Control can be performed to provide effect notification with different patterns depending on the splitting state of the enemy object.

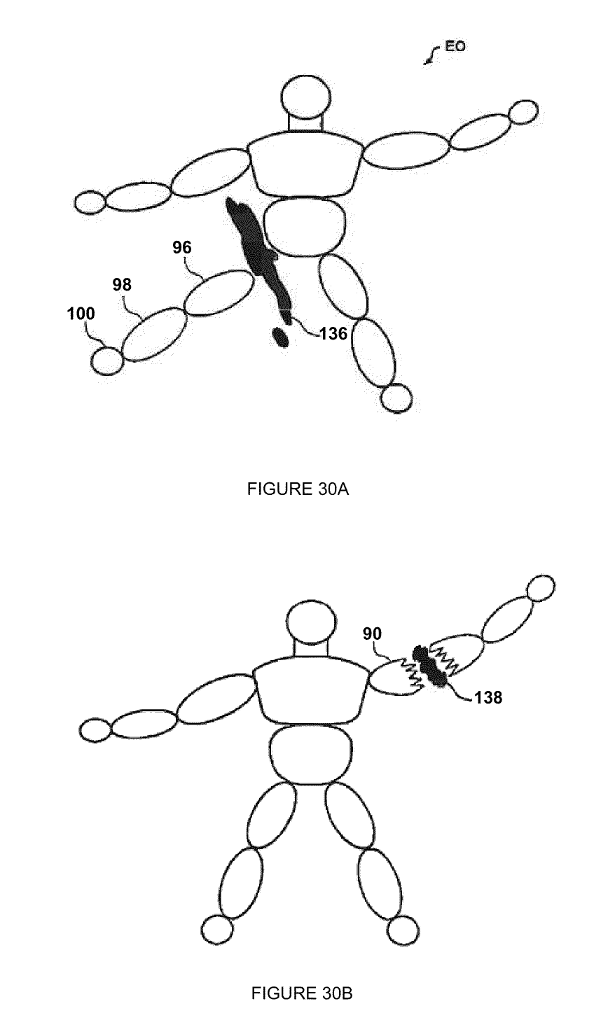

FIGS. 30A and 30B illustrate splitting states and effect patterns according to one embodiment of the invention. FIG. 30A illustrates a first splitting state where the enemy object EO has been split at the right thigh 96 and the effect display 136 that is displayed after splitting. FIG. 30B illustrates a second splitting state where the enemy object EO has been split at the left upper arm 90 and the effect display 138 displayed after splitting. In FIGS. 30A and 30B, liquid (such as oil, blood, etc.) discharged from the enemy object EO due to splitting is presented as an effect display. For some enemy objects EO, flames, lights, and/or internal components can be discharged as the effect display due to splitting.

As shown in FIGS. 30A and 30B, effect displays with different patterns can be displayed depending on the splitting state of the enemy object EO is different. In addition, as further described below, effect objects can be displayed with effect displays of different patterns, depending on the splitting state. Furthermore, different textures or shading patterns can be displayed with effect displays of different patterns, depending on the splitting state. Effect objects and different textures can be executed by image generation, while shading patterns can be executed by a pixel shader.

In some embodiments, game parameters (points, strength, difficulty levels, etc.) can also be computed based on splitting state. To compute points based on splitting state, the game can, for example, determine the split part based on the splitting state of the defeated enemy object and add the points defined for that part. Furthermore, the game can determine the number of split parts based on the splitting status and add points defined according to the number of parts.

Game parameters based on splitting states can make it possible to obtain points according to the damage done to the enemy object EO. Because the splitting state can be determined based on the representative point location information or split line information, the splitting state can be determined at any time during the game. The splitting state can also be determined based on representative point location information and split line information in modules other than the splitting processing module.

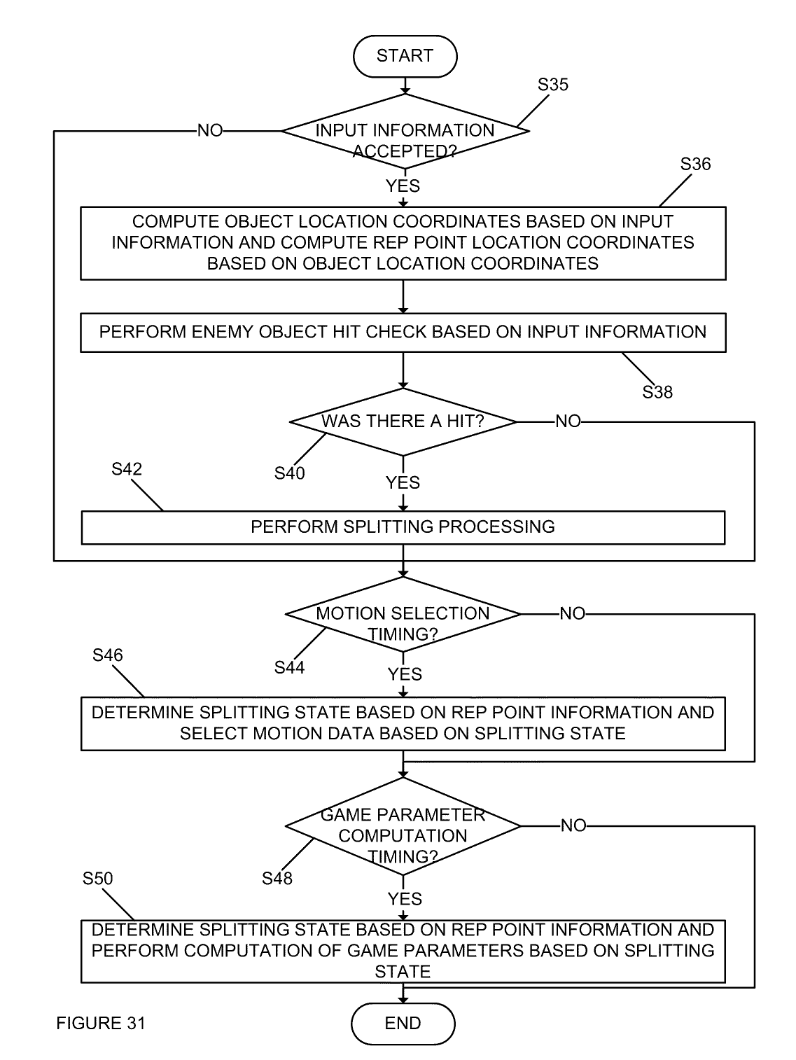

FIG. 31 illustrates a splitting processing method, according to one embodiment of the invention, where splitting state is determined based on representative point information. The following processing steps can be performed on a per-frame basis (i.e., for each frame). First, in step S35, it is determined if input information was accepted. If no input information was accepted, processing can proceed straight to step S44. If input information was accepted, the processing of steps S36 through S42 can be performed. In step S36, object location coordinates can be computed based on the input information and representative point location coordinates can be computed based on the object location coordinates. Following step S36, an enemy object hit check can be performed based on the input information at step S38. If there was a hit, as determined in step S40, splitting processing is carried out at step S42. If there was not a hit, as determined in step S40, processing can proceed straight to step S44.

For example, if the input information was attack instruction input information (step S34), a virtual plane can be defined from the player object to enemy objects located within a predetermined range based on the attack direction, player object location and orientation, and enemy object location (step S36). The attack direction can be determined based on the attack instruction input information (vertical cut attack input information or horizontal cut attack input information). Hit check processing of enemy object and virtual plane can then be performed (step S38), and if there is a hit (step S40), processing can be performed to sever (i.e., separate) the enemy object into multiple objects along the boundary of the defined virtual plane (step S42).

Following steps S34, S40, or S42, processing can determine if there is a need for motion selection timing at step S44. If so, splitting states can be determined based on representative point information and motion data selection can be performed based on the splitting states at step S46. If it is determined that no motion selection timing is necessary at step S44, or following step S46, processing can determine if game parameter computation timing is necessary at step S48. If so, splitting states are determined based on representative point information and computation of game parameters can be carried out based on the splitting states at step S50.

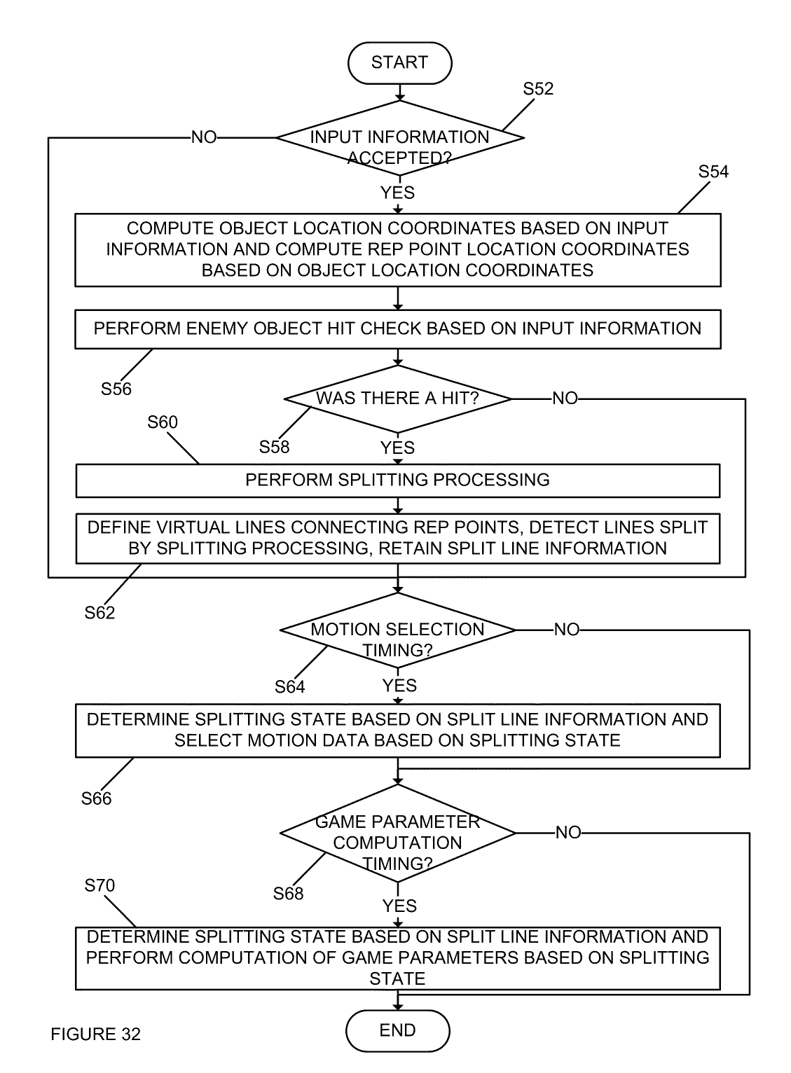

FIG. 32 illustrates a splitting processing method, according to another embodiment of the invention, where splitting state is determined based on split line information. The following processing steps can be performed on a per-frame basis (i.e., for each frame). First, in step S52, it is determined if input information was accepted. If no input information was accepted, processing can proceed straight to step S64. If input information was accepted, the processing of steps S54 through S62 can be performed. In step S54, object location coordinates can be computed based on the input information and representative point location coordinates can be computed based on the object location coordinates. Following step S54, an enemy object hit check can be performed based on the input information at step S56. If there was a hit, as determined in step S58, splitting processing is carried out at step S60. If there was not a hit, as determined in step S58, processing can proceed straight to step S64.

For example, if the input information was attack instruction input information (step S52), a virtual plane can be defined from the player object to enemy objects located within a predetermined range based on the attack direction, player object location and orientation, and enemy object location (step S54). The attack direction can be determined based on the attack instruction input information (vertical cut attack input information or horizontal cut attack input information). Hit check processing of enemy object and virtual plane can then be performed (step S56), and if there is a hit (step S58), processing can be performed to sever (i.e., separate) the enemy object into multiple objects along the boundary of the defined virtual plane (step S60).

Furthermore, the virtual lines connecting representative points can be defined, the line that was split by the splitting processing can then be detected, and split line information for the line that was split can be retained at step S62. Following steps S52, S58, or S62, processing can determine if there is a need for motion selection timing at step S64. If so, splitting states can be determined based on representative point information and motion data selection can be performed based on the splitting states at step S66. If it is determined that no motion selection timing is necessary at step S64, or following step S66, processing can determine if game parameter computation timing is necessary at step S68. If so, splitting states are determined based on representative point information and computation of game parameters can be carried out based on the splitting states at step S70.

In some embodiments of the invention, the game system 10 can provide processing to provide effect displays representing the damage sustained by an enemy object when the enemy object has been severed due to an attack by the player object.

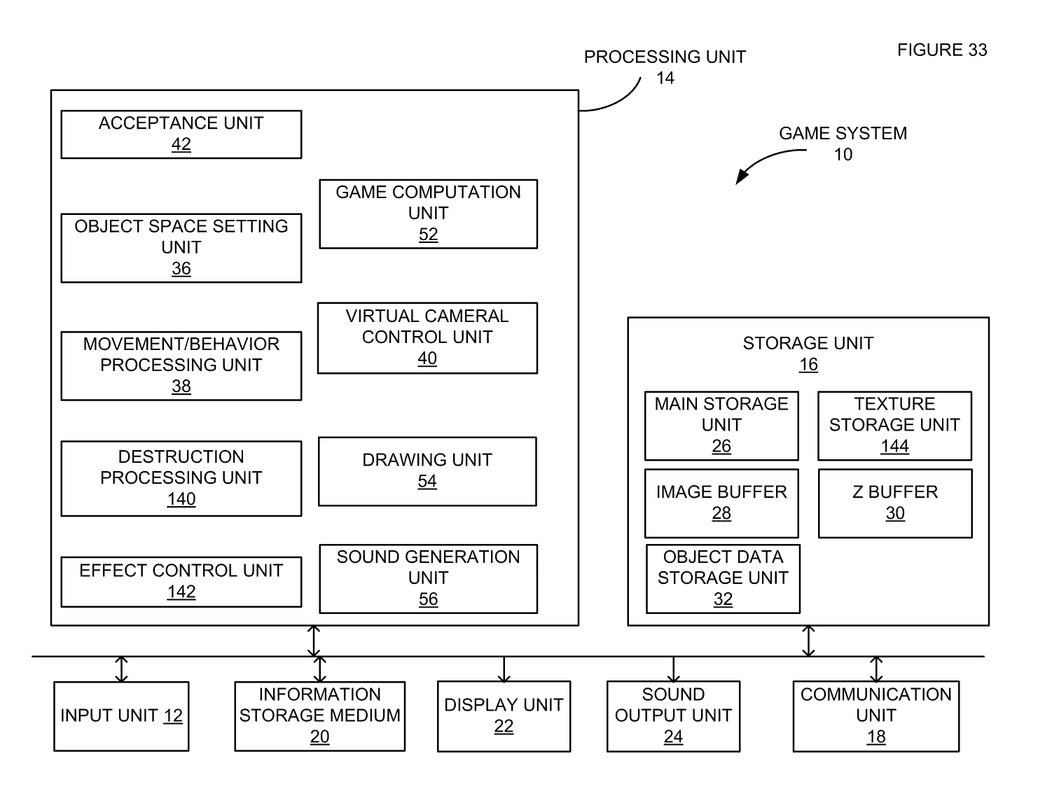

FIG. 33 illustrates the game system 10 including additional components to carry out representing appropriate effect displays based on damages sustained by severing. These additional components, although not shown, can also be included in the game system illustrated in FIG. 1 and/or 16.

The game system of FIG. 33 can include at least the input unit 12, the processing unit 14, the storage unit 16, the communication unit 18, the information storage medium 20, the display unit 22, the sound output unit 24, the main storage unit 26, the image buffer 28, the Z buffer 30, the object data storage unit 32, the object space setting unit 36, the movement and behavior processing unit 38, the virtual camera control unit 40, the acceptance unit 42, the severance processing unit 46, the hit effect processing unit 50, the game computation unit 52, the drawing unit 54, the sound generation unit 56.

The game system of FIG. 33 can also include a destruction processing unit 140, a effect control unit 142, a texture storage unit 144.

The destruction processing unit 140 can perform processing similar to the hit effect processing unit 50 and the severance processing unit 46, whereby, when attack instruction input information that causes a player object to attack another object has been accepted, the other object is severed or destroyed. Namely, it performs processing whereby the other object is divided into multiple objects, for example, using a virtual plane defined in relation to the other object. The other object can be divided into multiple objects along the boundary of the virtual plane based on the positional relationship between the player object and other object, the attack direction of the player object's attack, the type of attack, etc.

The effect control unit 142 can control the magnitude of effects representing the damage sustained by other objects based on the size of the destruction surface (i.e., the severed surface) of the other object. The effect which represents damage sustained by another object can be an effect display displayed on the display unit 22, a game sound outputted by the sound output unit 24, or a vibration generated by a vibration unit provided in the input unit 12. The effect control unit 142 can control the volume of game sounds or the magnitude (amplitude) of vibration generated by the vibration unit based on the size of the severed surface of the other object.

In addition, the effect control unit 142 can control the drawing magnitude of effect displays representing damage sustained by the other object based on the size of the severed surface. The effect display can represent liquid, light, flame, or other discharge released from the other object due to severing. The drawing magnitude of effect display can be based on, for example, the extent of use of a shader (e.g., number of vertices processed by a vertex shader, number of pixels processed by a pixel shader) when the effect display is drawn by a shader, the texture surface area (i.e., size) and number of times used if the effect display is drawn through texture mapping, or the number of particles generated if the effect display is represented with particles, and so forth.

Thus, the effect control unit 142 can control the magnitude of effects representing damage sustained by other objects or the drawing magnitude of effect displays representing damage sustained by other objects based on the surface area of said destruction surface, the number of said destruction surfaces, the number of vertices of said destruction surface, the surface area of the texture mapped to said destruction surface, and/or the type of texture mapped to said destruction surface.

When drawing objects, the drawing unit 54 can perform vertex processing (as described above), rasterization, pixel processing, texture mapping, etc. Rasterization (i.e., scanning conversion) can performed based on vertex data after vertex processing, and polygon (i.e., primitive) surfaces and pixels can be associated. Following the rasterization, pixel processing (e.g., shading with pixel shader, fragment processing), which draws the pixels making up the image, can be performed.

For the pixel processing, various types of processing such as texture reading (texture mapping), color data setting/modification, translucency compositing, anti-aliasing, etc. can be performed according to a pixel processing program (pixel shader program, second shader program). The final drawing colors of the pixels making up the image can be determined and the drawing colors of a transparency converted object can be outputted (drawn) to the image buffer 28. For the pixel processing, per-pixel processing in which image information (e.g., color, normal line, brightness, α value, etc.) is set or modified in pixel units can be performed. An image which can be viewed from a virtual camera can be generated in object space as a result.

Texture mapping is processing for mapping textures (texel values), which are stored in the texture storage unit 144, onto an object. Specifically, textures (e.g., colors, α values and other surface properties) can be read from the texture storage unit 144 using texture coordinates, etc. defined for the vertices of an object. Then the texture, which is a two-dimensional image, can be mapped onto the object. Processing to associate pixels and texels, bilinear interpolation as texel interpolation, and the like can then be performed.

In particular, the drawing unit 54, upon acceptance of attack instruction input information which causes the player object to attack another object, draws the effect display representing damage sustained by the other object in association with the other object according to the drawing magnitude controlled by effect control unit 115.

The following paragraphs describe execution of the game system 10, according to one embodiment of the invention, to provide effect displays representing the damage sustained by an enemy object when the enemy object has been severed due to an attack by the player object.

As described above, upon accepting “vertical cut attack input information,” processing can be performed whereby, as shown in FIG. 18A, a virtual plane VP is defined parallel to the vertical direction (Y axis direction) in relation to the enemy object EO that is the target of attack, and, as shown in FIG. 18B, the enemy object EO is separated into multiple objects EO1 and EO2 along the boundary of virtual plane VP. Furthermore, when “horizontal cut attack input information” is accepted, processing can be performed whereby, as shown in FIG. 19A, a virtual plane VP is defined parallel to the horizontal direction (X axis direction), in relation to the enemy object EO that is the target of attack, and, as shown in FIG. 19B, the enemy object EO is separated into multiple objects EO1 through E04 along the boundary of virtual plane VP.

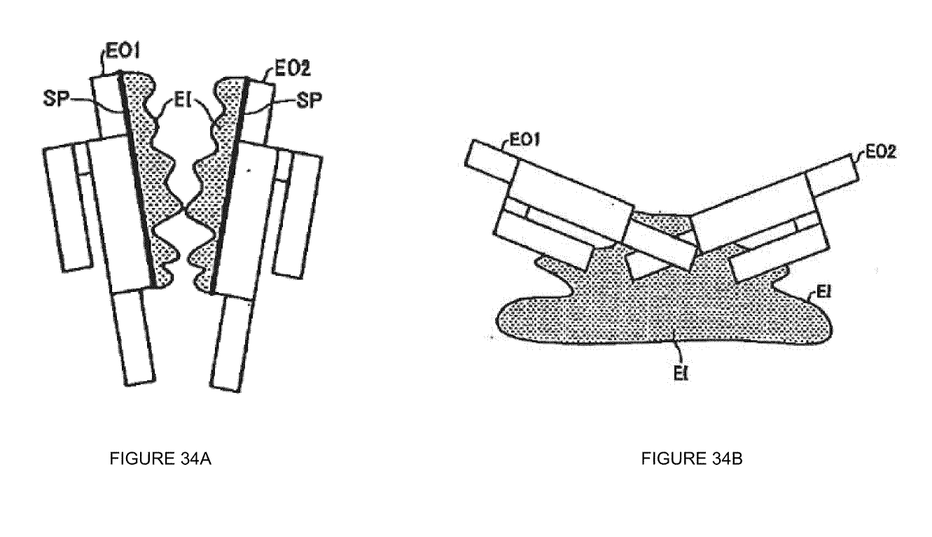

FIGS. 34A and 34B illustrate effect displays for an enemy object EO that has been severed due to a “vertical cut attack.” As shown in FIG. 34A, immediately after the enemy object EO has been severed, an effect display E1 is displayed. The effect display E1 can represent a discharge from the severed surfaces SP of separate objects EO1 and EO2.

In addition, as shown in FIG. 34B, once a predetermined period of time has elapsed after severing, an effect display EI can be displayed in the vicinity of the separated objects EO1 and EO2, representing a discharge spread over the ground after being discharged from the severed surface SP. The effect display EI shown in FIGS. 34A and 34B can represent a liquid, such as oil discharged due to severance from an enemy object EO, such as a robot. In some embodiments, flames, light, and or internal components coming out of the enemy object EO can be displayed as the effect display EI.

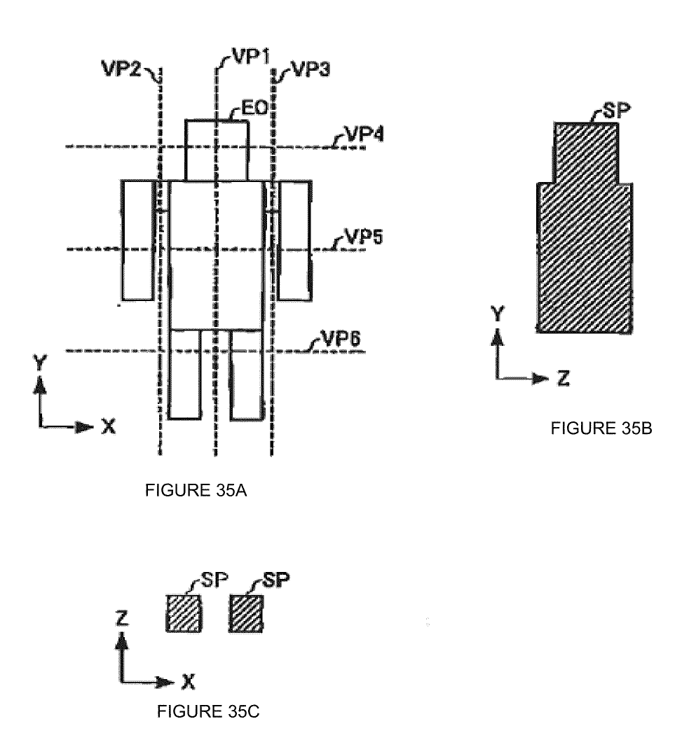

In some embodiments, the damage sustained by an enemy object EO due to severance can be effectively expressed by controlling the drawing magnitude of the effect display EI based on the size of a severance plane SP of the enemy object EO. The severance plane SP of an enemy object EO can be the surface where a virtual plane VP and the enemy object EO intersect. FIG. 35A illustrates an enemy object EO with a variety of possible virtual planes VP1-VP6. If the virtual plane is defined as virtual plane VP1, the severance plane SP would be that shown in FIG. 35B. If the virtual plane is defined as virtual plane VP6, the severance plane SP would be that shown in FIG. 35C. In some embodiments, the magnitude of an effect display EI can be controlled based on the surface area of the severed surface of the enemy object EO. For example, the drawing magnitude of the effect display EI can be controlled such that it is greater for larger surface areas that have been severed.

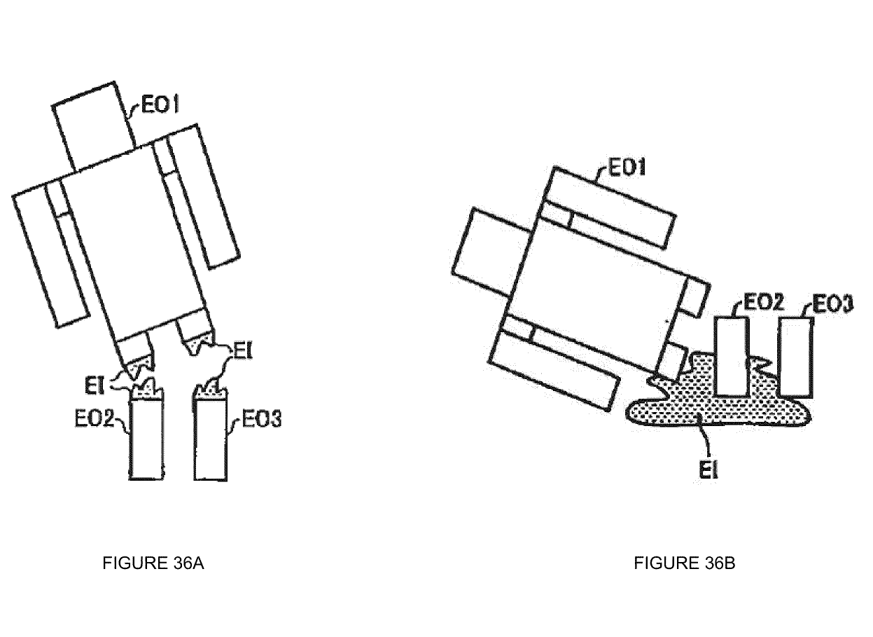

For example, when the virtual plane VP is virtual plane VP1 shown in FIG. 35A when the enemy object EO is severed, an effect display EI, such as that shown in FIG. 34A or 33B, can be drawn with a drawing magnitude corresponding to the area of the severance plane SP shown in FIG. 35B. When the virtual plane VP is virtual plane VP6 shown in FIG. 35A when the enemy object EO is severed, an effect display EI, such as that shown in FIGS. 36A and 35B can be drawn with a drawing magnitude corresponding to the area of the severance plane SP shown in FIG. 35C. FIG. 36A shows an effect display EI which represents matter discharged from the severance planes of multiple objects EO1, EO2, and E03 immediately after the enemy object EO is severed. FIG. 36B shows an effect display EI which represents discharged matter spreading to the ground after a prescribed amount of time has passed since the enemy object EO was severed.

The severance planes of the cases shown in FIGS. 34A and 34B have greater areas than the severance planes of the cases shown in FIGS. 36A and 36B. As a result, the drawing magnitude (e.g., drawing range) of the effect display EI is greater in the cases shown in FIGS. 34A and 34B than in the cases shown in FIGS. 36A and 36B.

A surface area of the severance plane SP can be calculated based on coordinates of the vertices of the severance plan SP. If there are multiple severed surfaces, as shown in FIG. 35C, the surface area can be computed by adding the separate surface areas of the severance plane SP. In addition, if multiple enemy objects EO have been severed simultaneously by a single attack, the surface area can be computed by adding the separate severed surfaces of the multiple enemy objects EO along the severance plane SP.

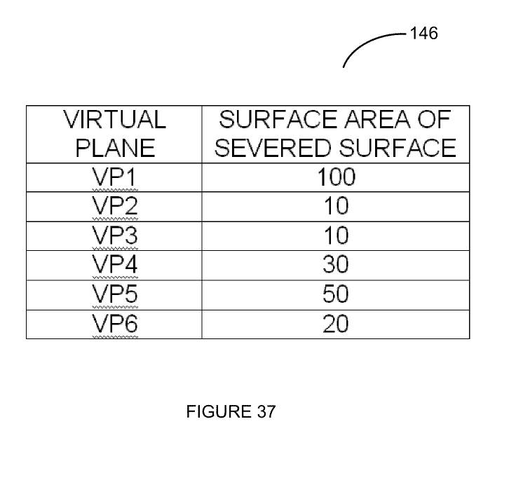

In some embodiments, predetermined multiple virtual planes VP, such as virtual planes VP1-VP6 shown in FIG. 35A, one can have stored surface area values. For example, as shown in FIG. 37, a table 146 can be used to store a surface area SP corresponding to each virtual plane VP. The table 146 can be stored in the storage unit 16 and can be referenced to determine the surface area of a severed surface SP corresponding to a predetermined virtual plane VP defined at the time of severing.

In some embodiments, instead of controlling the drawing magnitude of the effect display EI based on a surface area of the severance plane SP, the drawing magnitude of effect display EI can be controlled based on a number severance planes SP, a number of vertices of the polygon making up the severance plane SP, a surface area of the texture mapped onto the severance plane SP, or a type of texture mapped onto the severance plane SP. More specifically, the drawing magnitude of the effect display EI can be controlled such that it becomes larger with a larger number of severance planes SP, number of vertices of the polygon making up the severance plane SP, or surface area of the texture mapped onto the severance plane SP. For example, when the drawing magnitude of the effect display EI is based on the number of vertices processed by the shader or the number of pixels processed by the shader when drawing the effect display EI, the greater the area of the severance plane SP, the wider the range in which the effect display EI is drawn (i.e., range in a world coordinate system or a screen coordinate system).

In one embodiment, a player's points can be computed based on the drawing magnitude of the effect display EI. More specifically, points can be computed such that a higher score is given to the player when the drawing magnitude of the effect display EI is larger.

For example, since the drawing magnitude of the effect display EI shown in FIGS. 34A and 34B is greater than that of the effect display EI shown in FIGS. 36A and 36B, more points can be added to the player's score when an attack such as that shown in FIGS. 34A and 34B is performed compared to an attack such as that shown in FIGS. 36A and 36B is performed. In other words, the player can earn a higher score by performing many attacks in which the effect display EI is large (i.e., attacks in which the severance plane SP of the enemy object EO is large) and can earn points corresponding to the damage dealt to the enemy object EO. The drawing magnitude of the effect display EI can be calculated by finding the number of vertices processed by the shader or the number of pixels processed by the shader when drawing the effect display EI. The area of a texture or the number of times that a texture is used when drawing the effect display EI, the number of particles generated when drawing the effect display EI, or the load factor of the drawing processor when drawing the effect display EI can also be considered the drawing magnitude of the effect display EI.

A player's score can also be computed such that it increases as more objects are separated due to severance. For example, in the case shown in FIG. 34A, the enemy object is severed into two pieces, so an additional 2 points can be added to the score, and in the case shown in FIG. 36A, the enemy object is severed into three pieces, so an additional 3 points can be added to the score.

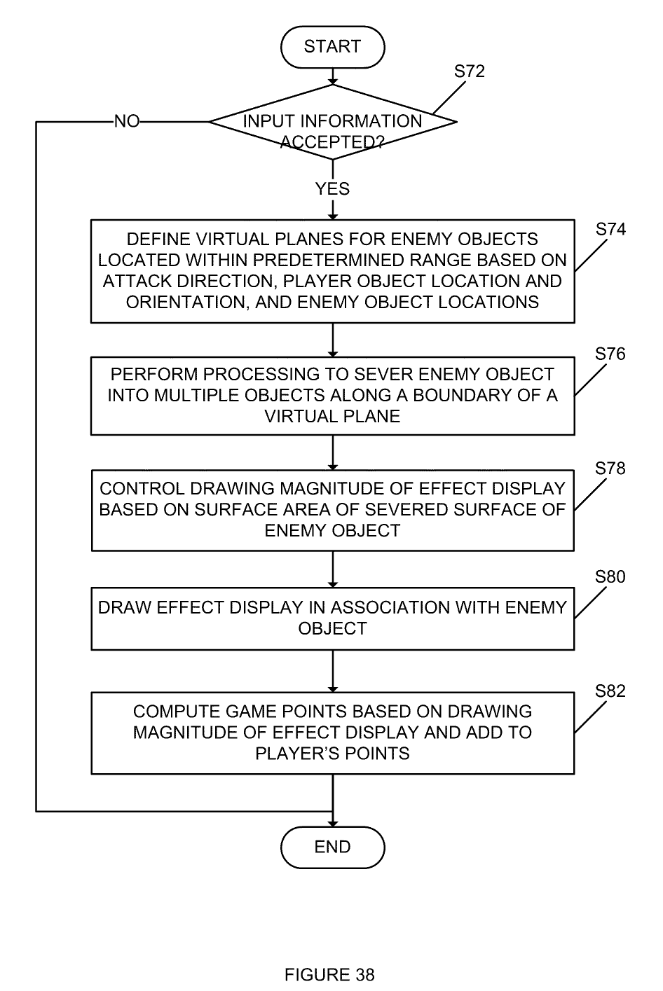

FIG. 38 illustrates a splitting processing method, according to one embodiment of the invention. The following processing steps can be performed on a per-frame basis (i.e., for each frame). First, in step S72, it is determined if attack instruction input information was accepted. If no input information was accepted, processing can be complete. If attack instruction input information was accepted, the processing of steps S74 through S82 can be performed. In step S74, a virtual plane can be set for an enemy object positioned within a prescribed range from the player object based on the position and orientation of the player object and the position of the enemy object. The attack direction can be determined based on the input information for the attack instruction (e.g., whether it is input information for a vertical or horizontal attack).

Following step S74, processing for severing the enemy object into multiple objects along the boundary of the virtual plane can be performed at step S76. Next, the surface area of the severance plane of the enemy object can be determined, and the drawing magnitude of the effect display can be controlled based on the surface area of the severance plan at step S78. The effect display can then be drawn in association with the enemy object at step S80. Following step S80, points can be computed based on the drawing magnitude of the effect display and added to the player's point total at step S82.

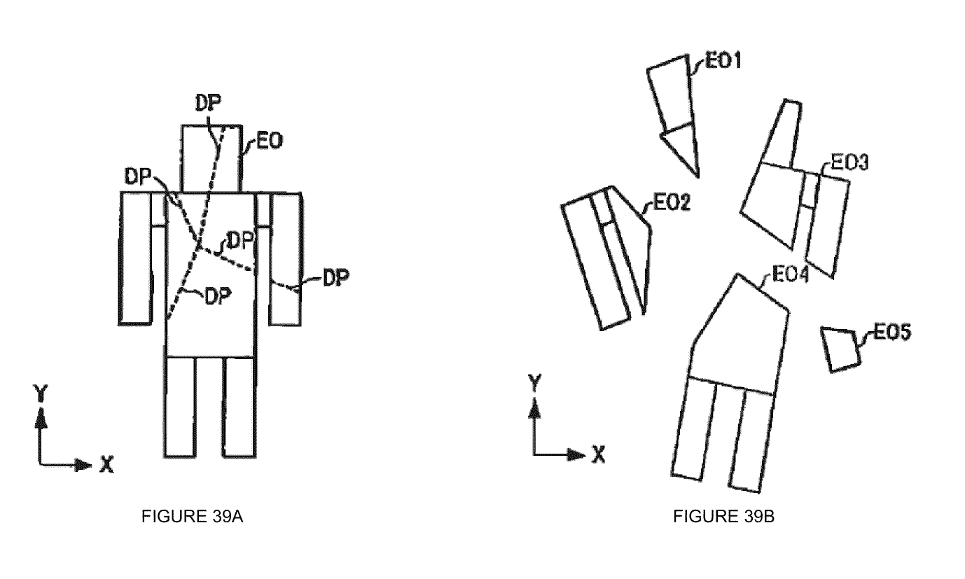

In some embodiments, enemy objects can be severed into multiple objects using multiple destruction planes DP, rather than a single virtual plane VP. For example, as shown in FIG. 39A, processing can be performed to separate enemy object EO at each destruction plane. FIG. 39B shows the multiple severing, resulting in multiple objects E01 through E05 from each destruction plane DP. In one embodiment, destruction planes DP can be implemented such that processing can be performed where the enemy object EO is separated into parts, such as a sepate head region, arm region, leg region, etc. The effect magnitude and the drawing magnitude of effect display can be controlled based on the number of destruction surfaces DP, the surface area, etc. The destruction plane method and accompanying processing can be implemented in games where the player object destroys enemy objects into pieces using a gun or similar weapon.

In some embodiments of the invention, the game system 10 can provide processing to bisect a skinned mesh (i.e., an enemy object) along a severance plane and cap the severed mesh. Severance boundaries can be arbitrary and therefore not dependent on any pre-computation, pre-planning or manual art process.

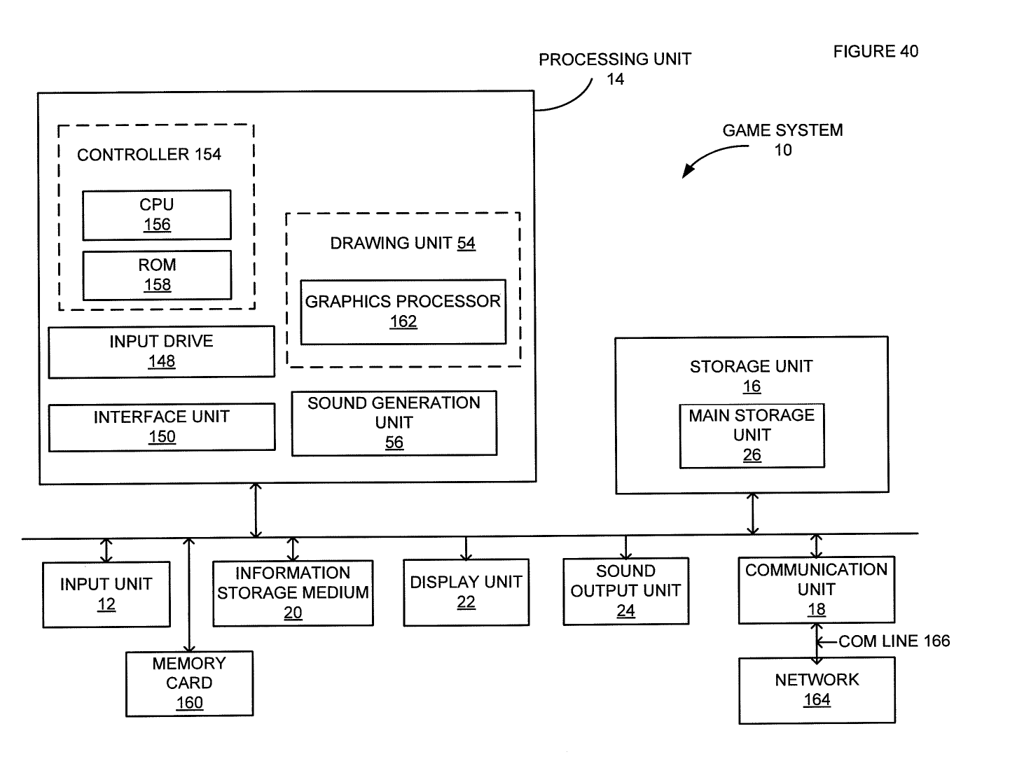

FIG. 40 illustrates the game system 10 including additional components to carry out severing skinned meshes and capping the severed meshes. These additional components, although not shown, can also be included in the game system illustrated in FIGS. 1, 16, and/or 32.

The game system 10 of FIG. 40 can include the input unit 12 (e.g., a videogame controller), the processing unit 14, the storage unit 16, the communication unit 18, the information storage medium 20, the display unit 22, the sound output unit 24, the main storage unit 26, drawing unit 54, and the sound generation unit 56.

The game system 10 of FIG. 40 can also include an input drive 148, an interface unit 150 and a bus 152. The bus 152 can connect some or all of the components of the game system 10, as shown in FIG. 40. The input drive 148 can be configured to be loaded with the information storage medium 20, such as a compact disc read only memory (CD-ROM) or a digital video disc (DVD). The input drive 148 can be a reader for reading data stored in the information storage medium 20, such as program data, image data, and sound data for the game program.

The processing unit 14 can include a controller 154 with a central processing unit (CPU) 156 and read only memory (ROM) 158. The CPU 156 can control the components of the processing unit 14 in accordance with a program stored in the storage unit 16 (or, in some cases, the ROM 158). Further, the controller 154 can include an oscillator and a counter (both not shown). The game system 10 can control the controller 154 in accordance with program data stored in the information storage medium 20.

The input unit 12 can be used by a player to input operating instructions to the game system 10. In some embodiments, the game system 10 can also include a removable memory card 160. The memory card 160 can be used to store data such as, but not limited to, game progress, game settings, and game environment information. Both the input unit 12 and the memory card 160 can be in communication with the interface unit 150. The interface unit 150 can control the transfer of data between the processing unit 14 and the input unit 12 and/or the memory card 160 via the bus 152.

The sound generation unit 24 can produce audio data (such as background music or sound effects) for the game program. The sound generation unit 24 can generate an audio signal in accordance with commands from the controller 154 and/or data stored in the main storage unit 26. The audio signal from the sound generation unit 24 can be transmitted to the sound output unit 24. The sound output unit 24 can then generate sounds based on the audio signal.

The drawing unit 54 can include a graphics processing unit 162, which can produce image data in accordance with commands from the controller 154. The graphics processing unit 162 can produce the image data in a frame buffer (such as image buffer 28 in FIG. 16). Further, the graphics processing unit 162 can generate a video signal for displaying the image data drawn in the frame buffer. The video signal from the graphics processing unit 162 can be transmitted to the display unit 22. The display unit 22 can then generate a visual display based on the video signal.

The communication unit 18 can control communications among the game system 10 and a network 164. The communication unit 18 can be connected to the network 46 through a communications line 166. Through the network 164, the game system 10 can be in communication with other game systems or databases, for example, to implement on-line gaming.

In some embodiments, the display unit 22 can be a television and the processing unit 14 and the storage unit 16 can be a conventional game console (such as a PlayStation®3 or an Xbox) physically separate from the display unit 22 and temporarily connected via cables. In other embodiments, the processing unit 14, the storage unit 16, the display unit 22 and the sound output unit 24 can be integrated, for example as a personal computer (PC). Further, in some embodiments, the game system 10 can be completely integrated, such as with a conventional arcade game setup.

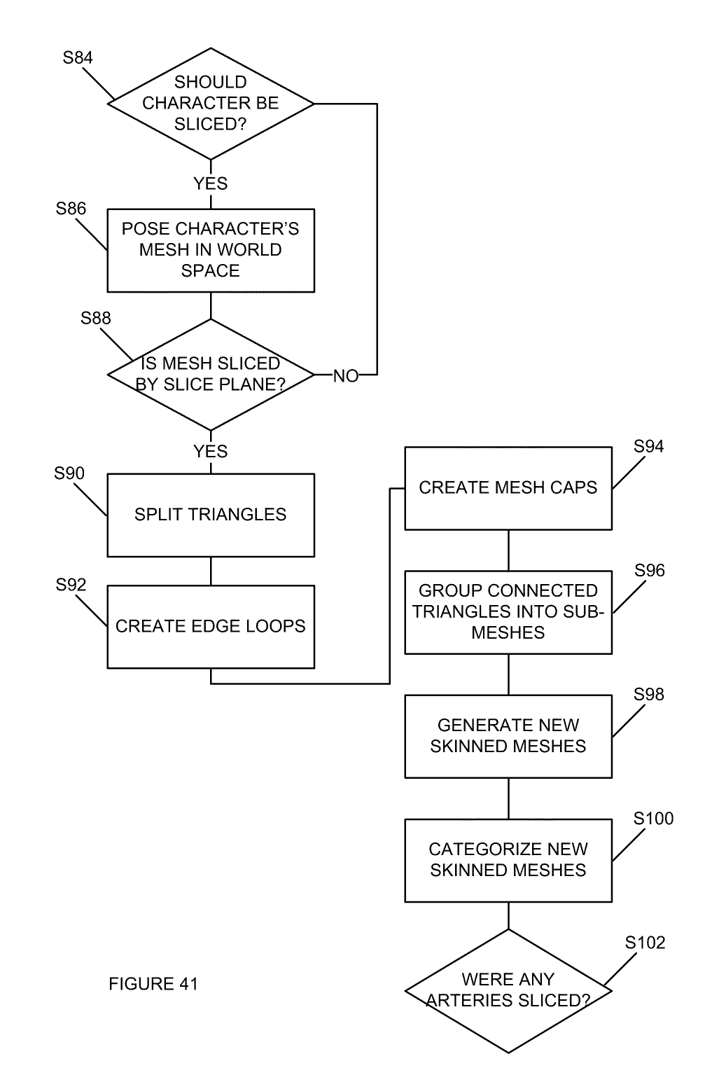

FIG. 41 illustrates a severing and capping processing method according to one embodiment of the invention. The method can include the following steps: determine if a character should be severed (step S84); pose the character's mesh in object space (step S86); determine if the mesh is in fact severed by the severance plane (step S88); if the mesh is severed by the severance plane, split triangles (step S90); create edge loops (step S92); create mesh caps (step S94); group connected triangles into sub-meshes (step S96); generate the new skinned meshes (step S98); categorize the new skinned meshes (step S100); and determine any arteries that were severed (step S102). The method steps can be written in software code and stored on the information storate medium 20 or on the network 164 and can be accessed and interpreted by the controller 154. In addition, the method steps can be instructions for the controller 154 to execute in real-time or near real-time while a player is playing the game system 10.

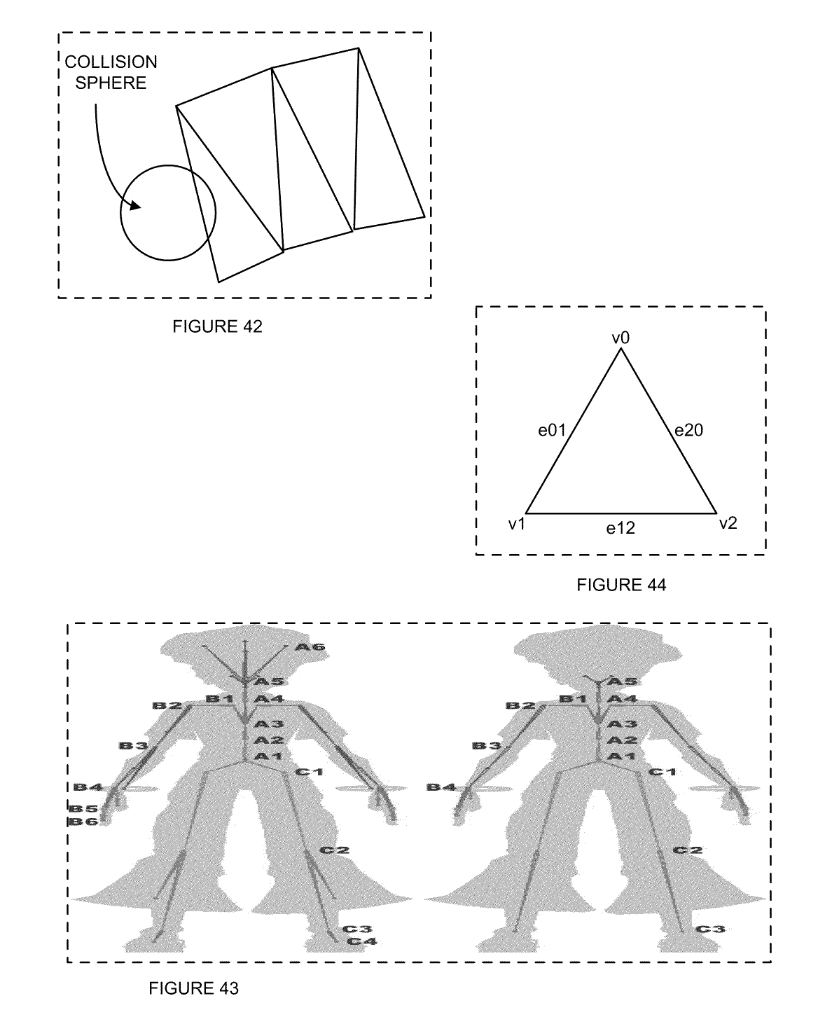

Step S84 of FIG. 41 determines if an object should be severed. Step S84 can be similar to collision detection where the object can be made up of a plurality of collision spheres surrounding a skeletal structure. Factors that can be taken into consideration during step S84 can be the player object's sword swing and the enemy object's collision spheres, skeletal structure, and pose. The sword swing can be decomposed into a series of line segments moving through object space over time. Two triangles can be constructed from consecutive line segments, as shown in FIG. 42. These triangles can be tested against posed collision spheres on the enemy object. If a triangle intersects a collision sphere, then it can be determined that the enemy object should be severed. A severance line (the axis along which the sword will slice) can be along a severance plane as defined by the triangle that intersects the collision sphere. The severance plane can be a plane in object space on which the severance line lies. All severing can be done in the object space. Also, the enemy object's skeleton (as shown in FIG. 43) can be defined as a hierarchy of transforms, or bones, as described above, and the character's pose can be a state of the transforms (local to the world) within the skeleton at a point in time.

Step S84 can also include predicting and displaying the severance line. For example, to predict where the player object will sever the enemy character, the game can animate forward in time, without displaying the results of the animation, and perform the triangle-to-posed-collision-sphere checks described above. In some embodiments, if a triangle hits a collision sphere, the severance plane defined by the triangle (the severance line) can become a white line drawn across the enemy object. The white line can be drawn as a “planar light” using an enemy object's pixel shader. In some embodiments, the player object can enter a specified mode (e.g., an “in focus” mode) for this prediction and display feature. In this specified mode, the enemy objects can move in slow motion and the player can adjust the severance line using the input unit 12 so that the player object can slice an enemy object at a specific point.

The severance line can be defined as a light source that emanates from the severance plane, passed as an argument to the enemy object's pixel shader. This light source can also have a falloff. The planar light's red, green and blue pixel components can all be greater than 1.0 in order for the planar light to be displayed as white.

Also taken into consideration in step S84 can be the enemy object's mesh. An object's mesh can be defined as an array of vertices and an array of triangles. Each vertex can contain a position, a normal, and other information. A series of three indices into the vertex array can create a triangle. Severing of posed meshes can often result in a large number of generated meshes.

An object can have four types of mesh: normal, underbody, clothing, and invisible. Normal meshes can be visible when the object is moving and attacking normally, and can be capped when sliced apart from the object. An example of a normal mesh can be a object's head. Underbody meshes can be invisible when the object is moving and attacking normally, but can become visible and capped as soon as the object is sliced apart. An example of an underbody mesh can be the bare legs of the object under the object's pants. Clothing meshes can be visible when the object is moving and attacking normally, but not capped when sliced apart. Invisible meshes can be used to keep parts of the object connected that would otherwise separate when sliced apart. For example, there can be invisible meshes that connect a head of the object to its eyes, which do not naturally share vertices with the head. The number of generated meshes can be limited by memory available and not by the complexity of the source skinned mesh or the current pose of the character.

Any mesh that is capped can be designed as watertight mesh. Watertight mesh can be designed to have no T-junctions and can be parameterized into a sphere. Topologies other than humanoid character shapes, such as those of an empty crate or a donut can be considered “non-spherically-parameterizable” meshes. In some embodiments, capping of the non-spherically parameterizable meshes is not supported. While it may happen infrequently, the intersection of a severance plane and a watertight humanoid mesh can still produce donut-shaped (and other non-circularly parameterizable) caps.

Step S86 of FIG. 41 can pose the object's mesh in object space. In step S86, standard skinning of the object can be performed. Positions of all vertices in the mesh in relation to the object space can be calculated given a pose.

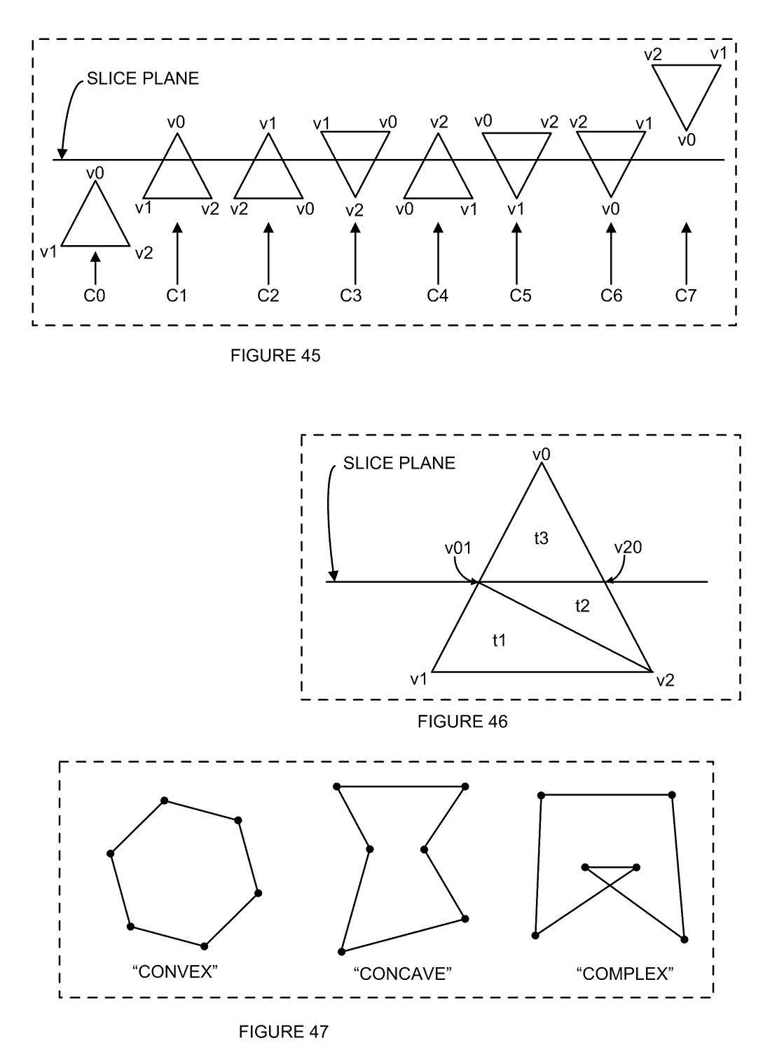

Step S88 of FIG. 41 can determine if the mesh is, in fact, severed by the severance plane. Step S88 is performed by determining whether or not any triangles straddle (i.e., overlap or intersect) the severance plane. Step S88 can be implemented through a brute-force loop program analyzing all triangles, in some embodiments. As illustrated in FIG. 44, each triangle can have three vertices: v0, v1, and v2. Each triangle can also have three edges, defined by the following: e01 is the edge between v0 and v1; e12 is the edge between v1 and v2; and e20 is the edge between v2 and v0. Each triangle can fall into one of eight categories illustrated in FIG. 45. Category C0 is where all vertices are below the severance plane. Category C1 is where only v0 is above the slice plane. Category C2 is where only v1 is above severance plane. Category C3 is where both v0 and v1 are above the severance plane. Category C4 is where only v2 is above the severance plane. Category C5 is where both v0 and v2 are above the severance plane. Category C6 is where both v1 and v2 are above the severance plane. Finally, Category C7 is where all vertices (v0, v1, and v2) are above the severance plane. In some embodiments, step S88 can be optimized to loop through a subset of triangles given the collision information gathered from step S84. If any triangle falls into categories C1-C6 then the triangle can be designated as severed by the severance plane and step S88 can be followed by step S90. If all triangles fall into categories C0 or C7, then it can be determined that no triangle is severed by the severance plane and the process can revert back to step S84.

Step S90 of FIG. 41 can split the severed triangles. Severed triangles, as determined in step S88, can be cut into a single triangle, t0, on one side of the severance plane and a quadrilateral (represented by two more triangles, t1 and t2) on another side of the severance plane, as shown in FIG. 46. Another loop can be implemented to generate and categorize one or more edge lists including all triangle edges coplanar with the severance plane. For example, for a triangle where v0 is above severance plane, two new vertices, v01 and v20, that lie on e01 and e20 respectively, can be created. To consistently calculate severance points, a distance above the severance plane can be divided by a total distance of the triangle. Alternatively, a distance below the severance plane can be divided by a total distance of the triangle. The two different calculation methods can be used so that the same edge used by two triangles can be split at the same spot. As mentioned above, the original severed triangle can be split into three new triangles, t0, t1, and t2, defined by the following vertices: t0=(v0, v01, v20); t1=(v01, v1, v2); t2=(v01, v20, v2). In addition, new edges can be created. For example, edge e01 to 20 can be defined as the edge between vertices v01 and v20. Edges can be added to the edge list if the mesh type requires a mesh cap (i.e., if it is normal mesh or underbody mesh).

In addition, linear interpolation can be used to calculate the positions and texture coordinates of the newly created vertices. The vertex normals, tangents, bone weights and bone indices from the vertex in the positive half-space of the severance plane can also be factors taken into consideration in some embodiments. The new triangles can be categorized into two lists: a list of triangles above the slice plane (e.g., t0 in FIG. 46) and a list of triangles below the slice plane (e.g., t1 and t2 in FIG. 46).

Step S92 of FIG. 41 can create edge loops. From the edge list, edge loops can be generated by finding and grouping edges that are connected. In some embodiments, a brute force loop can be implemented until there are no more lone edges (i.e., all edges have been connected). For example, a first edge from the edge list can be removed from the list and put it into another edge list, starting an edge loop. A second edge in the edge list that connects to the first edge can be removed from the edge list and put into the edge loop. This process can be repeated this until a last edge from the edge list is inserted into the edge loop. The last edge can also connect to the first edge in the edge loop. Also, multiple edge loops can be created in step S92. Each of the edge loops can create a polygon, as seen in FIG. 47.

Step S94 of FIG. 41 can create mesh caps. Each polygon created in step S92 can represent the basis of a mesh cap. The mesh cap can be generated by calculating UVs (i.e., location points along “U” and “V” axes) for the vertices in the polygon and triangulating the polygon. Mesh caps can be split into two sets: one set for the meshes above the severance plane and one set for meshes below the severance plane. Once triangulated, each cap can be added to an appropriate list of triangles (i.e., either a list of triangles above the slice plane or a list of triangles below the slice plane). UVs can be calculated by mapping the fractional distance along the edge loop to the circumference of a circle. The cap (e.g., meat) texture that will be displayed within this circle can be drawn by an artist and can be a consistent image in all caps or can vary with different caps. Triangulating a convex polygon can be fairly straightforward. In some embodiments, a convex polygon can be triangulated by creating a triangle “fan” which originates from a vertex in the polygon.

Other polygons, such as those that are concave, are not well-formed, or have crossing edges, can require other techniques. One example of a non-convex polygon can be the complex edge loop of FIG. 47, which can be a common result of a bending of bones in a skinned mesh. Triangulating a concave polygon can require an operation which cuts off a portion, or an ear, of the polygon.

In determining the shape of a polygon, cross products between adjacent edges can be calculated. Given two source line segments (i.e., two edges with a common vertex), the cross product of these segments results in a line segment that is perpendicular to both source segments and has a length equal to the area of the parallelogram defined by the source segments. With two-dimensional geometry, the cross product of two line segments results in a scalar whose value can be compared to zero to determine the relationship between the line segments (i.e., whether it is a clockwise relationship or a counterclockwise relationship). This two-dimensional cross-product can therefore be used to determine if the angle formed by two segments is convex or concave in the context of a polygon with a specific winding order. For example, if adjacent edges have both clockwise and counterclockwise relationships, then the polygon is concave.

The winding order of the polygon can be an important factor when trying to cut off an ear of the polygon. First, it is determined whether an angle created by two adjacent edges of the polygon is a convex angle for the polygon or a concave one. This is done using a cross-product of the two edge segments, as discussed above. Next, convex angles (also known as ears) can be cut off the polygon, if no other polygon vertices lie within the triangle defined by the convex angle. This check for other polygon vertices can be necessary for proper triangulation of the two-dimensional polygon. The check, however, can be overlooked in some steps during triangulation of a mesh cap. If a convex angle cannot be cut off, then the next convex angle in turn is considered. A loop can be implemented to cut off ears one by one until all that is left is a last triangle.

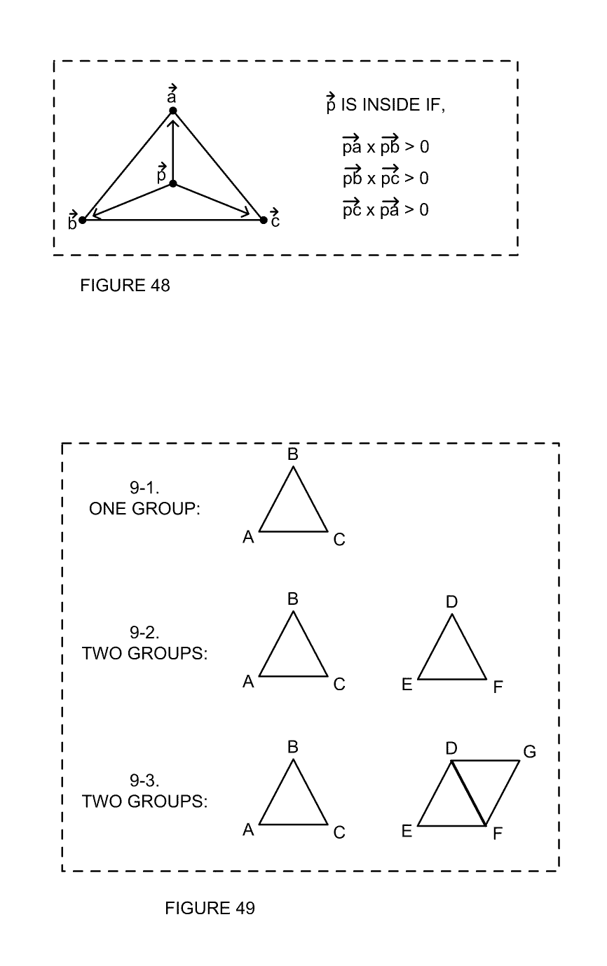

There are several techniques that can be used to determine if a point lies within a triangle. For example, cross products of the point with segments connecting the point with the vertices of the triangle can be used, as shown in FIG. 48. If all the cross products have the same sign, depending on the winding order, then the point is contained within the triangle.

The goal of triangulation can be to create a mesh cap that, when unfolded because of animation movement, still maintains the “watertightness” of a new mesh. Conventional standard triangulation of two-dimensional complex polygons where crossed edges create vertices at crossed intersections can be used in some embodiments. However, in other embodiments, four pass triangulation, as described below, can be used.

Because some edge loops can be complex and cross edges can potentially represent polygons that are “folded over” themselves, triangulation can require four passes. Pass 1 can be the conventional triangulation of a concave polygon defined in a counter-clockwise order. Pass 2 can be the same as Pass 1 except all convex angles (triangles) are cut off, including ones which contain other polygon vertices. Pass 2 can be known as a forced pass. Pass 3 and Pass 4 can be the same as Pass 1 and Pass 2 except a clockwise ordering is assumed. Pass 4 can also be a forced pass.

In some embodiments, triangulations using different pass orders can be used. For example, success in triangulation can result by starting over with Pass 1 again. This can generate more “ideal” triangulations. Another example can be to alter the pass order, such as performing Pass 1, then Pass 3, then Pass 2, then Pass 4. This can save forcing the triangulation (in Passes 2 and 4) for later which can sometimes result in better triangulations. In some embodiments, any triangulation that is generated is typically a best guess and animation and movement of vertices after triangulation generally means a “perfect” triangulation cannot be generated.

Step S96 of FIG. 41 can group connected vertices (i.e., triangles) into combined meshes. Connected vertices can be grouped by putting triangles (represented by three connected or grouped vertices) one by one into a MinGroup structure. The MinGroup structure can take, successively, n-items that are considered part of the same group. For example, a triangle with vertices (A, B, C) can be been inserted. Then, a triangle with vertices (D, E, F) can be been inserted. This can create two groups: (A, B, C) and (D, E, F). If another triangle with vertices (D, F, G) is inserted, the MinGroup structure can connect and consolidate (D, E, F) and (D, F, G) into (D, E, F, G), as shown in FIG. 49. The two groups can now be (A, B, C) and (D, E, F, G).

If A through G represent vertices and each n-item of three vertices that is inserted represents a triangle, then after inserting all triangles (as three vertices) into the MinGroup structure, the structure can contain a minimal number of groups of connected vertices. Groups of connected vertices can be used to generate new meshes created using the severance plane as a separator.

Step S98 of FIG. 41 can generate new skinned meshes. In generating the new skinned meshes, a specific data structure can be used. The data structure can be a “DynamicMesh”, which is a mesh that can be easily modified and added to. The DynamicMesh can be similar to a standard template library (STL) map, where successive insertions of triangles into the structure can build up a minimal representation of the mesh. For example, triangles (in the form of three vertices, each of which includes position, normal, UVs and other information) can be added one by one and the DynamicMesh can keep track of repeated vertices and determine vertex indices of each triangle. There can be three types of mesh structures. From low-level to high, the three types of mesh structures can be mesh, “FullSkinMesh”, and DynamicMesh, where mesh is fully compressed and ready to draw, FullSkinMesh has vertices that are uncompressed and is convertible to mesh and DynamicMesh is a high level book keeping structure and is convertible to FullSkinMesh.

Step S98 can loop through each grouping of triangles and create a DynamicMesh for each grouping of triangles. To do this, each triangle in each group can be added to the DynamicMesh. This process loop can be implemented until all triangles have been added. The triangles can be added as three vertices (including position, normals, UVs, and other information), then the DynamicMesh is converted into FullSkinMesh and the FullSkinMesh is finally converted into a mesh.

Step S100 of FIG. 41 can categorize new skinned meshes. In some embodiments, the meshes created can be categorized by noting which bones are active in each mesh. A bone can be considered active if a vertex in the mesh is influenced by that bone. Therefore, if a mesh only contains head and spine bones but no leg bones, it can be categorized as a “Top Half” piece. If a mesh only contains the left ankle bone but not the left knee, the mesh can be categorized as a “Left Foot” piece. Once severed, it is possible that not all bones in a source mesh will influence newly created sub-meshes. For example, if a character's fingers are sliced off, only the finger bones can be active for those finger meshes.

In some embodiments, there can be twenty body part types that a mesh can be categorized into (“top half”, “left foot”, etc.). How these body part types act can be further defined and can be specific to each enemy object. In all object, there can be two behaviors for body parts: a severed part can either become a gib or a giblet.

Gibs can be light-weight animated skinned meshes. Gibs can fall to the ground, orient to the ground over time and animate. Gibs can also require death animations. For example, once the player object has severed an enemy character in half vertically, the left half of the enemy object can display an animation in which it falls left, while the right half of the enemy object can display a different animation of falling right.

Giblets can be derived from RigidChunks, which in turn can be derived from modified Squishys. Details of the Squishy technology, which can be modified in some embodiments, can be found in the article “Meshless Deformations Based on Shape Matching” (http://www.beosil.com/download/MeshlessDeformations_SIG05.pdf), which is incorporated herein by reference.

Step S102 of FIG. 41 can determine any arteries that may have been sliced. Arteries can be defined by an arbitrary lines along a bone, or transform. In some embodiments, only a limited subset of the bones include arteries. While creating mesh caps, all arteries in the source mesh can be analyzed to determine which arteries intersect the cap (i.e., the severed end of the object). These can be the arteries that are severed in the severing operation. These arteries can be recorded (e.g., their position and orientation) for future reference. In the case that arteries are severed in the severing operation, display effects such as blood exiting from the artery (i.e., the artery's position in the capped mesh) can be displayed.

Since the result of a low-level severing operation is a series of meshes that are the same type as the source mesh, meshes can be severed multiple times, recursively. By either altering the characteristics of gibs and giblets formed by severing an object, or generating a new behavior for severed parts, higher-level severing operations can be performed multiple times on already-severed meshes of objects.

Severing a rigid mesh can also be taken into consideration. Severing a rigid mesh can actually be simpler than severing a skinned mesh because posing of the skinned mesh (step S86) as well as the handling of bone weights (in step S100) and indices can be omitted. This can be done by supporting a rigid vertex format in addition to a skinned vertex format. In some embodiments, rigid meshes can also be designed as watertight meshes so that they can be severed similar to the meshes described above with respect to steps S84 and S88-S102.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A computer-readable storage medium tangibly storing a program for generating images in a object space viewed from a given viewpoint, the program causing a game system used by a player to function as:
an acceptance unit which accepts player input information for a first object with a weapon in the object space;
a display control unit which performs processing to display a severance line on a second object based on the player input information while in a specified mode; and
a severance processing unit which performs processing to sever the second object along the severance line.

2. The computer-readable storage medium of claim 1, wherein said display control unit moves the severance line based on directional instruction input information from the player that has been accepted by the acceptance unit.

3. The computer-readable storage medium of claim 1, wherein the program further causes the game system to function as a mode switching unit which performs processing to switch from a normal mode to a specified mode when specified mode switch input information from the player has been accepted by the acceptance unit, and wherein the display control unit displays the severance line when the player input information is accepted while in the specified mode.

4. The computer-readable storage medium of claim 3, wherein the acceptance unit accepts specified mode switch input information from the player when a given game value is at or above a predetermined value.

5. The computer-readable storage medium of claim 3, wherein the program further causes the game system to function as a movement processing unit which performs processing whereby the first object is moved based on directional instruction input information from the player which has been has been accepted by the acceptance unit while in the normal mode, and whereby the severance line is moved based on the directional instruction input information from the player which has been has been accepted by the acceptance unit while in the specified mode.

6. The computer-readable storage medium of claim 1, wherein the display control unit displays the severance line based on an attack direction defined by the player input information.

7. The computer-readable storage medium of claim 1, wherein the display control unit displays the severance line in accordance with the type of weapon that the first object is equipped with.

8. The computer-readable storage medium of claim 1, wherein the display control unit displays the severance line according to the type of the second object.

9. The computer-readable storage medium of claim 1, wherein the display control unit displays the severance line so as to avoid non-severable regions if non-severable regions have been defined for the second object.

10. The computer-readable storage medium of claim 1, wherein the display control unit moves the severance line according to movement and behavior of the second object.

11. The computer-readable storage medium of claim 1, wherein the severance processing unit performs processing whereby the second object is separated into multiple objects.

13. A game system for use by a player wherein a first object attacks a second object in an object space, the game system comprising:
an acceptance unit which accepts player input information from the player;
a display control unit which performs processing that causes a severance line to be displayed on the second object based on the player input information under specific conditions; and
a severance processing unit which performs processing to sever the second object along said severance line.

14. A computer-readable storage medium tangibly storing a game program for generating images in a object space viewed from a given viewpoint, the program causing a game system used by a player to function as:
an acceptance unit which accepts input information from the player;
a representative point location information computation unit which defines representative points on an object and calculates location information for the representative points based on the input information;
a splitting processing unit which performs splitting processing to determine whether the object should be split based on the input information and to split the object into multiple sub-objects if it has been determined that the object should be split;
a splitting state determination unit which determines a splitting state of the object based on the location information of the representative points; and
a processing unit which performs image generation processing and game parameter computation processing based on the splitting state of the object.

15. The computer-readable storage medium of claim 14, wherein the representative points are defined in association with object parts making up the object, and
the splitting state determination unit determines the positional relationship between a first object part and a second object part based on the location information of the representative points associated with the first part and the second part, and determines that a splitting state exists if the positional relationship satisfies predetermined splitting conditions.

16. The computer-readable storage medium of claim 1, wherein the representative point location information computation unit computes location information of the representative points defined in the multiple sub-objects after the object has been split.

17. The computer-readable storage medium of claim 14, wherein the program further causes the game system to function as a split line detection unit which defines virtual lines connecting the representative points, detects when the virtual lines are split by the splitting processing unit, and stores split line information for identifying the virtual lines which have been split.

18. The computer-readable storage medium of claim 14, wherein the processing unit includes a movement and behavior processing unit which performs one of determining movements and behavior patterns of the multiple sub-objects after splitting and performing image generation processing according to the determined movement and behavior pattern and determining effect patterns associated with the multiple sub-objects after splitting and performing image generation processing according to the determined effect patterns.

19. The computer-readable storage medium of claim 18, wherein the movement and behavior processing unit stores motion data of different patterns in association with the splitting states, selects the motion data based on the splitting state, and performs image generation using the selected motion data.

20. The computer-readable storage medium of claim 14, wherein the processing unit includes a game computation unit that computes game parameters based on splitting states and performs game computations based on the computed game parameters.

21. A game system, for use by a player, which generates images of objects being split in an object space, the game system comprising:
an acceptance unit which accepts input information from the player;
a representative point location information computation unit which defines multiple representative points on an object and calculates location information for the representative points based on the input information;
a splitting processing unit which performs splitting processing to determine whether the object should be split based on the input information and to split the object into multiple sub-objects if it has been determined that the object should be split;
a splitting state determination unit which determines a splitting state of the object based on split line information; and
a processing unit which performs image generation processing and game parameter computation processing based on the splitting state.

22. The game system of claim 21 and further comprising a split line detection unit which defines split lines connecting the representative points, detects when the split lines are split by the splitting processing unit, and stores the split line information for identifying the split lines which have been split.

23. A computer-readable storage medium tangibly storing a game program for generating images in a object space viewed from a given viewpoint, the program causing a game system used by a player to function as:
an acceptance unit which accepts player input information from the player to destroy an object;
a destruction processing unit which, upon acceptance of the input information, performs processing whereby the object is destroyed; and
an effect control unit which controls the magnitude of effects representing the damage sustained by the object based on a size of a destruction surface of the object caused by the destruction processing unit.

24. The computer-readable storage medium of claim 23, wherein the effect control unit controls the magnitude of effects based on at least one of a surface area of the destruction surface, a number of destruction surfaces, a number of vertices of the destruction surface, a surface area of a texture mapped to the destruction surface, and a type of texture mapped to the destruction surface.

25. The computer-readable storage medium of claim 23, wherein the program further causes the game system to function as a drawing unit which draws an effect display representing the damage sustained by the object, and wherein the effect control unit controls the drawing magnitude of the effect display based on the size of the destruction surface of the other object.

26. The computer-readable storage medium of claim 25, wherein the effect control unit controls the drawing magnitude of the effect display based on one of a surface area of the destruction surface, a number of destruction surfaces, a number of vertices of the destruction surface, a surface area of a texture mapped to the destruction surface, and a type of texture mapped to the destruction surface.

27. The computer-readable storage medium of claim 25, wherein the effect display represents a discharge which is discharged from the object due to destruction.

28. The computer-readable storage medium of claim 25, wherein the program further causes the game system to function as a point computation unit which computes player points based on a drawing magnitude of the effect display.

29. A game system, for use by a player, which generates images of objects attacking other objects in an object space, the game system comprising:
an acceptance unit which accepts player input information from the player;
a destruction processing unit which, upon acceptance of the input information, performs processing whereby the other object is destroyed; and
an effect control unit which controls the magnitude of effects representing the damage sustained by the object based on a size of a destruction surface of the object caused by the destruction processing unit.

30. The game system of claim 29 and further comprising a drawing unit which draws an effect display representing the damage sustained by the object, and a point computation unit which computes player points based on a drawing magnitude of the effect display.

32. A computer-readable storage medium tangibly storing a game program for generating images in a object space viewed from a given viewpoint, the program causing a game system used by a player to function as:
an acceptance unit which accepts player input information for a first object in the object space; and
a processing unit which performs processing to
create a severance plane based on the player input information,
define a mesh structure for at least a second object,
determine whether the severance plane intersects the mesh structure of the second object in the object space,
if the severance plane and the second object intersect, sever the second object into multiple sub-objects with severed ends along the severance plane,
define mesh structures for the multiple sub-objects, and
create and display caps for the severed ends of the multiple sub-objects.

33. The computer-readable storage medium of claim 32, wherein the processing unit further performs processing to determine appropriate effect displays based on the severed ends of the multiple sub-objects and display the appropriate effect displays.
